(19) United States
(12) Patent Application Publication
(10) Pub. No.: US 2025/0020594 A1
(43) Pub. Date: Jan. 16, 2025

(54) Super-Resolution Microscope for 3D cell and Tissue Imaging

(71) Applicant: Georgia Tech Research Corporation, Atlanta, GA (US)

(72) Inventors: Shu Jia, Johns Creek, GA (US); Biagio Mandracchia, Atlanta, GA (US); Kidan Tadesse, Atlanta, GA (US); Kyungduck Yoon, Atlanta, GA (US)

(21) Appl. No.: 18/773,425

(22) Filed: Jul. 15, 2024

Related U.S. Application Data
(60) Provisional application No. 63/513,674, filed on Jul. 14, 2023.

(51) Int. Cl. G01N 21/64; G02B 21/00; H04N 23/951

(52) U.S. Cl. CPC G01N 21/6458; G02B 21/0036; G02B 21/0076; G02B 21/008; H04N 23/951; G01N 2021/6463; G01N 2201/06113

(57) ABSTRACT

A multifocal scanning microscopy (MSM) for super-resolution imaging was developed with multicolor acquisition and minimal instrumental complexity. MSM implements a stationary, interposed multi-focal multicolor excitation by exploiting the motion of the specimens, realizing super-resolution microscopy through a general epi-fluorescence platform without compromising the image-scanning mechanism or inducing complex instrument alignment. The system is demonstrated with various phantom and biological specimens, and the results present effective resolution doubling, optical sectioning, and contrast enhancement. MSM, as a highly accessible and compatible super-resolution technique, may offer a promising methodological pathway for broad cell biological discoveries.

### RELATED APPLICATION

This application claims priority to U.S. Provisional Patent Application No. 63/513,674, filed Jul. 14, 2023, which is incorporated herein by reference in its entirety.

### STATEMENT OF GOVERNMENT SUPPORT

This invention was made with government support under Grant No. R35GM124846, awarded by the National Institutes of Health. The government has certain rights in this invention.

### BACKGROUND

Epi-fluorescence microscope is the most commonly used fluorescence microscopy method in life sciences to visualize cell morphology and cellular/subcellular compartments. Epi-fluorescence microscope employs an objective lens that is used for both the illumination condenser and the fluorescent light collector and is often equipped with a high-intensity light source that emits light in a broad spectrum from visible through ultraviolet to provide incident illumination to illuminate the sample from above.

Structured illumination microscopy (SIM) harnesses patterned illumination to recover high spatial frequencies, extracting sub-diffraction limited details from emitted fluorescent signals. SIM and its associated methodologies have attracted increasing interest due to notable advantages, such as effective resolution doubling, rapid image acquisition, and compatibility with standard sample preparation protocols.

Image-scanning microscopy (ISM), a confocal form of SIM, significantly enhances the super-resolution capabilities of traditional interference-based SIM by employing diffraction-limited focal excitation to capture all permissible spatial frequencies of the microscope and a detector array, with each pixel functioning as a discrete pinhole. ISM combines the strengths of both structured illumination and confocal microscopy to provide enhanced optical sectioning, an uncompromised signal-to-noise ratio (SNR), rapid volumetric acquisition, and optical super-resolution through subsequent spatial-frequency demixing. Wider adoption of image-scanning microscopy systems remains constrained by existing optical configurations that entail intricate instruments and precise alignment and calibration. Furthermore, the scanning processes in current image-scanning microscopy systems, which involve confocal spinning disks, galvanometric mirrors, or digital micromirror devices, hinder their convenient and cost-effective integration with commonly used frameworks, such as epi-fluorescence microscopes.

Therefore, there is a benefit to improving image-scanning microscopy and epi-fluorescence microscope systems.

### SUMMARY

An exemplary multifocal scanning microscopy (MSM) system and method are disclosed that employs a stationary multi-foci microlens array (MLA), e.g., in an image-scanning microscopy system or epi-fluorescence scanning microscopy system, to generate a multifocal excitation pattern that provides a projection of an array of diffraction-limited foci onto a moving sample to which fluorescence emission from the sample is recorded by an array of detectors (e.g., camera) to reconstruct a super-resolution image. The reconstructed images can be multi-color or three-dimensional.

To capture multi-focal images, in some embodiments, a motorized sample stage is continuously scanned while traveling in a scanning direction (e.g., at a speed of 20 μm/sec) while the array of detectors synchronously acquire the images at high speed (e.g., 200 frames per second). Contrary to existing spot-scanning approaches, MSM can employ the stationary multifocal configuration while leveraging the 3D motion of the specimen to realize, e.g., a two-fold resolution improvement in all three dimensions, e.g., on an epi-fluorescence platform and other conventional microscopy setups and sample protocols.

The term “sample,” as used herein, refers to a biological specimen such as cells or cellular compartment compartments, e.g., for multicolored staining imaging, live-cell imaging, thick specimen imaging, and tissue imaging, among others. Sample can also refer to environmental fluids having biological and non-biological components.

In an aspect, a system is disclosed comprising one or more laser sources, including a first laser device; a microlens array optically connected to the first laser device, the microlens array having a plurality of microlens elements configured to generate a plurality of beams from a laser beam of the first laser source to provide a multifocal excitation pattern; an optics assembly coupled to the microlens array, the optics assembly being configured to generate diffraction-limited foci from the multifocal excitation pattern and project the diffraction-limited foci on a sample; and a sensor (e.g., camera) configured to capture fluorescence rays emitted from the sample as fluorescent signals to provide raw multi-focal images, including (i) a first image captured at a first position and (ii) a second image captured at a second position, wherein at least one of the sample or the optics assembly is configured to move during a scan to provide a capture of the sample by the sensor while the sample or the multifocal excitation pattern is moving in relation to one another, and wherein the first image and the second image are used to generate a high-resolution image (3D or multicolor) via a reconstruction algorithm.

In some embodiments, the system described herein further comprises a motorized stage configured to move the sample in one or more directions (e.g., a first direction, x-axis; a second direction, y-axis; and a third direction, z-axis) to provide the first image at the first position and (ii) the second image captured at the second position.

In some embodiments, the optics assembly is configured to move to allow the scanning of the sample at different orientations with respect to the camera to provide the first image at the first position and (ii) the second image captured at the second position.

In some embodiments, the one or more laser sources include a second laser device, the system further comprising a second optics assembly to combine (i) the first laser beam and (ii) a second laser beam from the second laser device to generate the laser beam. In some embodiments, the one or more laser sources include a second laser device, the system further comprising a second optics assembly having (i) a first portion configured to direct the laser beam of the first laser device to a first portion of the microlens array and (ii) a second portion configured to direct a second laser beam to a second portion of the microlens array (e.g., wherein the first portion and second portion of the microlens array overlap spatially in part of whole, or wherein the first portion and second portion of the microlens array do not overlap spatially).

In some embodiments, the first laser beam and the second laser beam have different wavelengths.

In some embodiments, the first laser beam and the second laser beam have same wavelengths.

In some embodiments, the system described herein further comprises an image processing unit having a processor and a memory having instructions stored thereon to generate the high-resolution image (3D or multicolor), wherein execution of the instructions by the processor causes the processor to: generate, via a digital pinhole mask, one or more pinholed images from the first image and second image, wherein the one or more pinholed images eliminate out-of-focus lights from the first image and second image; generate one or more intermediate images by reassigning pixels of the pinholed images (e.g., based on a doubling size of distance between each focus); and produce super-resolution images by overlaying the one or more intermediate images with each other in a deconvolution operation.

In some embodiments, the image processing unit is further configured to track, via a tracking pattern, the raw multi-focal images to remove non-uniform movement errors (e.g., wherein the step to remove includes a cross-correlation operation or correction of the tracking pattern via a fit to a linear plot).

In some embodiments, the system described herein further comprises a controller configured to perform calibration to identify a location of each illumination spot across a field of view of the sensor, wherein the each illumination spot corresponds to each of the diffraction-limited foci (e.g., wherein the calibration involves receiving a plurality of fluorescent dyes; imaging a plurality of images of the plurality of fluorescent dyes; and generating a slide containing a uniform distribution of fluorescent dyes by averaging the plurality of images of the plurality of fluorescent dyes).

In some embodiments, for multicolor reconstruction, the system described herein comprises an image processing unit having a processor and a memory having instructions stored thereon to generate the high-resolution image (3D or multicolor), wherein execution of the instructions by the processor causes the processor to receive stored coordinates of the diffraction-limited foci acquired using a calibration slide containing a uniform distribution of fluorescent dyes, wherein the stored coordinates are recorded into separate spectral channels; generate, via a digital pinhole mask, two or more pinholed images from the first image and second image, wherein the two or more pinholed images eliminate out-of-focus lights from the first image and second image, and wherein the two or more pinholed images are separated into the separate spectral channels based on the stored coordinates; generate one or more intermediate images by reassigning pixels of the pinholed images (e.g., based on a doubling size of distance between each focus); and produce the high-resolution image by overlaying the one or more intermediate images with each other (e.g., in a deconvolution operation).

In some embodiments, the system described herein further comprises a controller configured to (i) direct the sample in one or more directions, (ii) direct operations of the one or more laser sources, and (iii) direct scanning operations of the sensor.

In some embodiments, the microlens array is a multicolor microlens array comprising (i) a first set of first color array elements and (ii) a second set of second color array elements.

In some embodiments, the first set of first color array elements forms a first grid, and the second set of second color array elements forms a second grid, wherein the first grid is interposed among the second grid (e.g., wherein first grid and second grid are parallel to one another in a first direction and a second direction and offset by half distance of each grid element).

In some embodiments, the optics assembly is configured to direct the fluorescent rays emitted from the sample to the sensor.

In an aspect, a method is disclosed comprising generating a laser beam from a laser source; scanning a sample by generating a plurality of beams from the laser beam to provide a multifocal excitation pattern using a microlens array; directing the multifocal excitation pattern to project the multifocal excitation pattern as diffraction-limited foci on a sample while the sample is moving; moving the sample in a first direction; and capturing fluorescence rays emitted from the sample as fluorescent signals as the sample is moving to generate (i) a first image at a first position and (ii) a second image at a second position; and reconstructing a high-resolution image (3D or multicolor), via a reconstruction operation, using the first image and the second image.

In some embodiments, scanning operations comprise one or more directions, including a first direction, a second direction, a third direction, and a combination thereof.

In some embodiments, for 3D image reconstruction, the reconstruction operation involves generating, via a digital pinhole mask, one or more pinholed images from the first image and second image, wherein the one or more pinholed images eliminate out-of-focus lights from the first image and second image; generating one or more intermediate images by reassigning pixels of the pinholed images (e.g., based on a doubling size of the distance between each focus); and producing super-resolution images by overlaying the one or more intermediate images with each other in a deconvolution operation.

In some embodiments, for multicolor reconstruction, the reconstruction operation involves receiving stored coordinates of the diffraction-limited foci acquired using a calibration slide containing a uniform distribution of fluorescent dyes, wherein the stored coordinates are recorded into separate spectral channels; generating, via a digital pinhole mask, two or more pinhole images from the first image and second image, wherein the two or more pinholed images eliminate out-of-focus lights from the first image and second image, and wherein the two or more pinholed images are separated into the separate spectral channels based on the stored coordinates; generating one or more intermediate images by reassigning pixels of the pinholed images (e.g., doubling the size between each focus); and producing the high-resolution image by overlaying the one or more intermediate images with each other (e.g., in a deconvolution operation).

In an aspect, a non-transitory readable medium is disclosed having instructions stored thereon, wherein execution of the instructions by a processor causes the processor to direct generation of a laser beam from a laser source; direct scanning of a sample by generating a plurality of beams from the laser beam to provide a multifocal excitation pattern using a microlens array; directing the multifocal excitation pattern to project the multifocal excitation pattern as diffraction-limited foci on a sample while the sample is moving; moving the sample in a first direction; and capturing fluorescence emissions from the sample as fluorescent signals as the sample is moving to generate (i) a first image at a first position and (ii) a second image at a second position; and reconstructing a high-resolution image (3D or multicolor), via a reconstruction operation, using the first image and the second image.

### BRIEF DESCRIPTION OF THE DRAWINGS

The accompanying drawings, which are incorporated in and constitute a part of this specification, illustrate embodiments and, together with the description, serve to explain the principles of the methods and systems.

Embodiments of the present invention may be better understood from the following detailed description when read in conjunction with the accompanying drawings. Such embodiments, which are for illustrative purposes only, depict novel and non-obvious aspects of the invention. The drawings include the following figures:

FIGS. 1A-1C each shows an example MSM system comprising a first optics assembly, a second optics assembly, a multilens array, a sensor, a controller, an image processing unit, and a sample stage carrying a sample, in accordance with an illustrative embodiment.

FIG. 2A shows an example 3D MSM system configured to project a multifocal excitation pattern having one or more different wavelengths of light on to a moving sample, which is scanned by a motorized stage and captured by a camera.

FIG. 2B shows an example multicolor MSM system configured to project a multicolor excitation pattern having one or more different wavelengths of light onto a moving sample, which is scanned by a motorized stage and captured by a camera.

FIG. 2C shows an example multilens array employed in the MSM system of FIGS. 1A or 1B in accordance with an illustrative embodiment.

FIG. 3A shows an example image reconstruction process for the 3D MSM system.

FIGS. 3B and 3C show an example image reconstruction process for the multicolor MSM system.

FIG. 4A shows an example calibration process for the MSM system.

FIG. 4B shows an example camera external triggering mechanism for the MSM system.

FIG. 5 shows an example sample stage configuration of an MSM system configured as a photofluidic microscope.

FIG. 6 shows an example prototype of the MSM system comprising a microlens array, a telescope, a dichroic mirror, and a motorized stage.

FIGS. 7A-7C each shows an example sample to be scanned by the MSM system.

FIG. 8A shows example image reconstruction processes for the 3D MSM system and the wide-field (WF) system.

FIG. 8B shows examples of WF and 3D MSM imaging of phantom samples for system characterization.

FIG. 9A-9C each shows example images generated by the WF system and the 3D MSM system.

FIG. 10A shows example image reconstruction processes for the multicolor MSM system and the WF system.

FIG. 10B shows examples of WF and multicolor imaging of phantom samples for system characterization.

FIGS. 11A-11B each shows example images generated by the WF system and the multicolor MSM system.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

### Example System

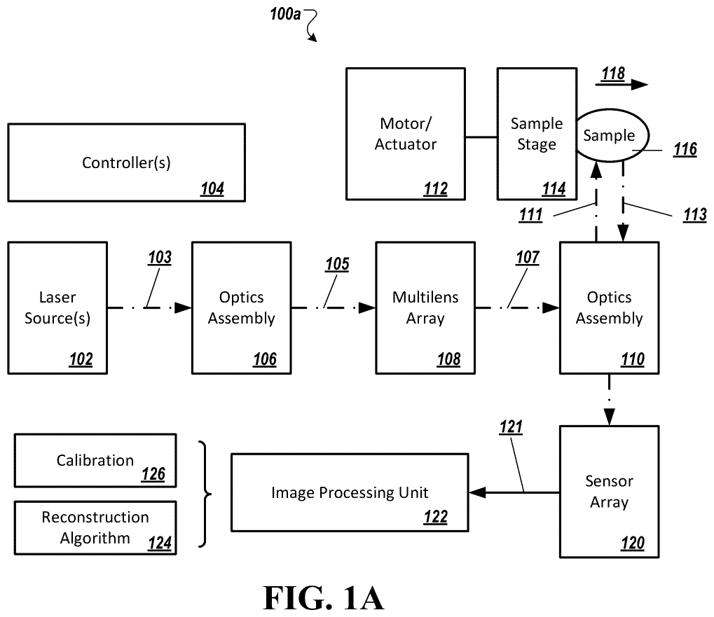

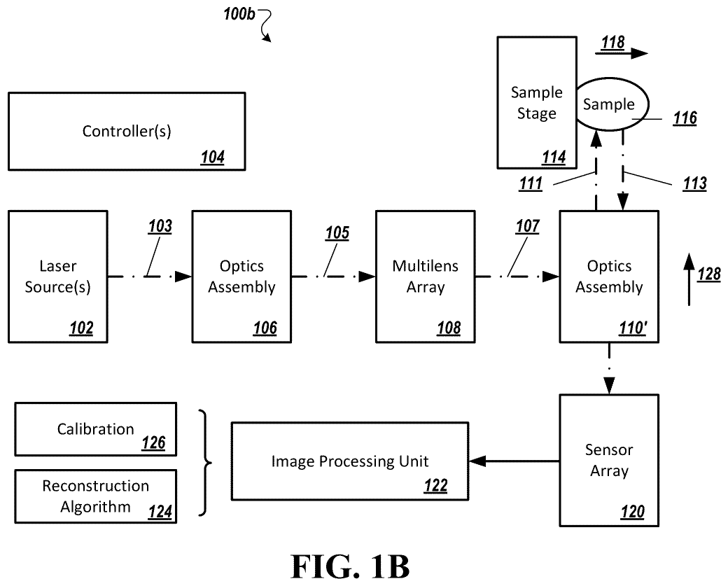

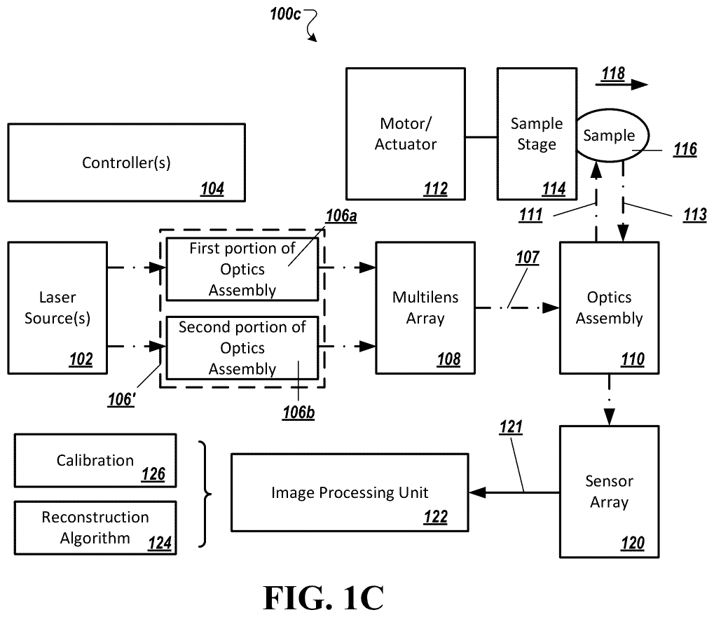

FIGS. 1A-1C each shows an example multifocal scanning microscopy (MSM) system 100 (shown as 100a, 100b, 100c) that employs a stationary multi-foci microlens array (MLA), e.g., in an image-scanning microscopy system, epi-fluorescence scanning microscopy system, among other microscope systems described herein, to generate a multifocal excitation pattern that provides a projection of an array of diffraction-limited foci onto a moving sample to which fluorescence emission from the sample is recorded by an array of detectors (e.g., camera) to reconstruct a super-resolution image. FIG. 1A shows the MSM system 100a configured to capture images of the sample while the sample is moving, e.g., while the sample is being scanned. FIG. 1B shows the MSM system 100b configured to capture images of the sample by moving the projections of the diffraction-limited foci.

In the example shown in FIG. 1A, the MSM system 100a includes one or more laser source 102, controller 104, optics assemblies 106, 110, a multilens array 108, and motor/actuator 112, and sample stage 114 along a first optical path to generate a diffraction-limited foci onto a moving/scanning sample 116. The MSM system 100a includes a sensor array 120 and imaging processing unit 122 to capture images from the samples in a second optical path to generate high-resolution images from multiple scans having the diffraction-limited foci acquired of the moving/scanning sample 116.

Specifically, in FIG. 1A, the laser source 102 emits one or more laser beams 103 to the optics assembly 106 that directs the laser beams 105 to the multilens array 108 to generate a multifocal excitation pattern 107.

The multilens array 108 is optically coupled to the second optics assembly 106 and directs the multifocal excitation pattern 107 to the optics assembly 110 to generate a diffraction-limited multifocal excitation pattern 111.

The optics assembly 110 is optically coupled to the multilens array 108 and projects the diffraction-limited multifocal excitation pattern 107 from the multilens array 108 onto the sample 116 that is positioned on the sample stage 114. The projection of the diffraction-limited multifocal excitation pattern 111 onto the sample 116 causes fluorescent emissions 113 emitted from the diffraction-limited foci pattern 111/sample 116 back through the optics assembly 110 to the sensor array 120. The sensor array 120 converts the fluorescent emissions 113 to images 121 that are provided to the image processing unit 122 for image reconstruction. The image reconstruction process is coupled to a reconstruction algorithm 124 and a calibration 126.

Laser source 102 can include one or more lasers to generate multiple spectra of visible and/or ultraviolet light to provide incident illumination of the sample 116. In some embodiments, a single laser having a broad spectrum of visible and/or ultraviolet light is employed. In other embodiments, two or more lasers, each having a distinct spectrum of visible and/or ultraviolet light, are employed. The spectrum of each laser can be overlapping or separate. For example, a first laser 102 (referred to as 102a) can be in the blue and/or violet spectrum, having wavelengths between about 400 nanometers (nm) and 500 nm range, and a second laser 102 (referred to as 102b) can be in the red spectrum having wavelengths near 650 nm wavelengths, e.g., between about 600 nm and 670 nm. In addition to lasers, other intense, near-monochromatic illumination sources can be used to provide fluorescence of a sample (e.g., biological sample), including, for example, and not limited to xenon arc lamps, mercury-vapor lamps with an excitation filter, supercontinuum sources, and high-power LEDs.

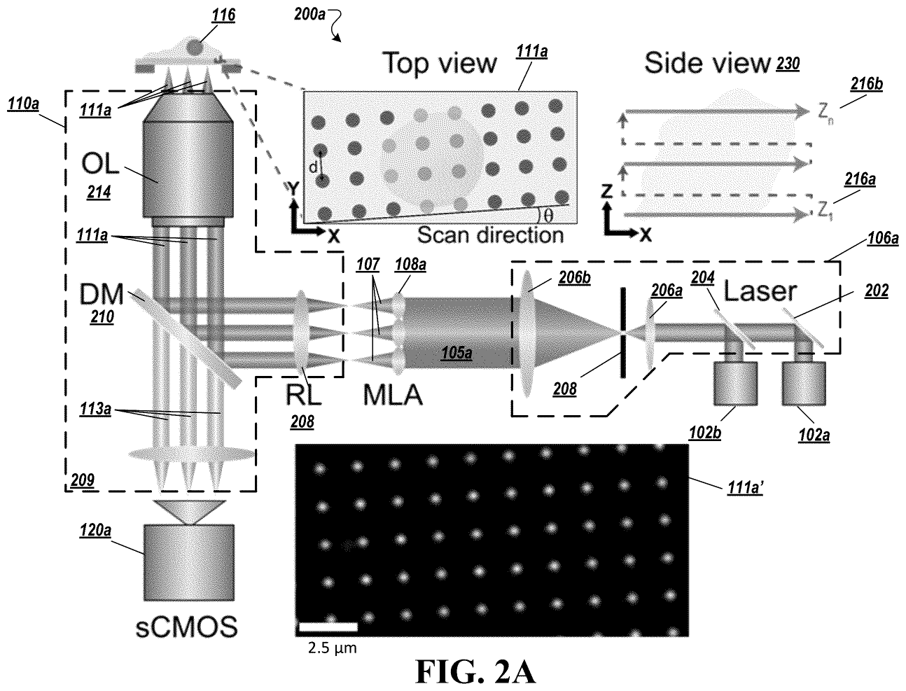

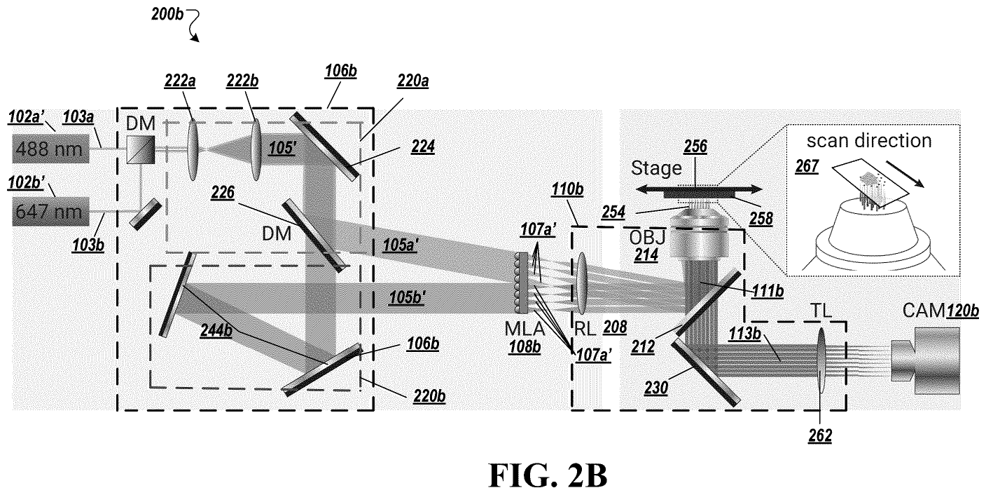

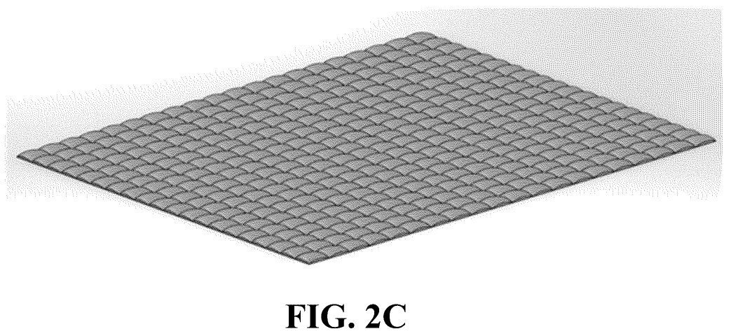

Optics assembly 106 is configured to direct the laser beams 105 to the multilens array 108 to generate a multifocal excitation pattern 107. In some embodiments, the optics assembly 106 includes one or more relay lenses (RLs), dichroic mirrors (DMs), and objective lenses (OLs) configured to combine multiple laser beams (e.g., 105) into a single beam and focus it on the multilens array 108. In other embodiments, the optics assembly 106 is configured to separately direct the multiple laser beams (e.g., 105) to the multilens array 108. The optics assembly 106 may include filters and other lenses. Example configurations of optics assembly 106 are provided in FIGS. 2A and 2B for an image-scanning microscope or epi-fluorescence scanning microscope configuration. Other optics for fluorescence scanning microscopes and image-scanning microscopes, among others, can be used.

Multilens array (MLA) 108 is configured to generate a multifocal excitation pattern from a laser line. The multilens array 108 is formed of a single lens body, e.g., made of polymer-on-glass. In other embodiments, the multilens array 108 is formed of multiple lenses that are cut and fixably adhered to one another to form a single body structure. In some embodiments, the multilens array 108 comprises a substrate having multiple convex (or concave) surface elements formed on one or both of the substrate's surfaces. Each of the multiple convex (or concave) surface elements has its own individual focal point to collectively form the multifocal excitation pattern.

Optics assembly 110 includes a dichroic mirror (DMs) and one or more objective lenses (OLs) configured to direct the diffraction-limited multifocal excitation pattern 107 from the multilens array 108 onto the sample 116 as well as to direct fluorescent emissions 113 emitted from the diffraction-limited foci pattern 111/sample 116 back through the optics assembly 110 to the sensor array 120. That is, the diffraction-limited foci pattern is a relayed image of the diffraction-limited multifocal excitation pattern 107 on the sample. The optics assembly 110 may include filters and other lenses. Example configurations of optics assembly 106 are provided in FIGS. 2A and 2B for an image-scanning microscope or epi-fluorescence scanning microscope configuration. Optics assembly 110 may include diffractive optical elements for simultaneous multiplane imaging [38, 39]. Other optics for fluorescence scanning microscopes and image-scanning microscopes, among others, can be used. Additionally, in some embodiments, various optical focusing operations may be employed to enable higher volumetric frame rates [40].

Motor/actuator 112 may include motors and/or linear actuators to provide high-precision movement of the sample stage 114 in a scanning direction 118. The scanning direction 118 may be in one or more directions, e.g., along a plane or along a three-dimensional path. The motor/actuator 112 may be controlled by the controller 114 which coordinates the operation with the sensor array acquisition subsystem. Examples of high precision movement include step size, as non-limiting examples, of 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm. In some embodiments, the motor/actuator 112 can provide high-precision movement with step sizes less than 100 nm. In some embodiments, the Motor/actuator 112 can provide movements with step sizes greater than 500 nm, e.g., and as non-limiting examples, 600 nm, 700 nm, 800 nm, 900 nm, 1 μm, 2 μm, 3 μm, 4 μm, 5 μm, 6 μm, 7 μm, 8 μm, 9 μm, 10 μm, among others.

Sample Stage 114 is configured to house glass slides or other containers having sample 116. In some embodiments, the sample stage 114 is integrated into or coupled to a microfluidic device or flow chamber, e.g., in a photofluidic microscope system.

Sample 116 can be a biological specimen such as cells or cellular compartment compartments, e.g., for multicolored staining imaging, live-cell imaging, thick specimen imaging, tissue imaging, e.g., used for fluorescence scanning microscopes, image-scanning microscopes, among other imaging systems described or referenced herein. Sample 116 can also refer to fluid having biological and non-biological components.

Sensor array 120, also referred to as an array of detectors, is configured to convert the fluorescent emissions 113 acquired or scanned from the sample 116 to images 121 (e.g., for storage) and provides the scanned or stored images 121 to the image processing unit 122 for image reconstruction. In some embodiments, the sensor array 120 is a camera, e.g., charged coupled device (CCD), CMOS sensor, or scientific Complementary Metal-Oxide-Semiconductor (sCMOS) configured to provide high-resolution images. The sensor array 120 can provide, in some embodiments, extremely low noise (e.g., noise of ˜1 e⁻), rapid frame rates (e.g., greater than 100 fps, e.g., 200 fps, etc.), wide dynamic range, high quantum efficiency (e.g., peak quantum efficiency of 95%), high resolution, and/or a large field of view (e.g., greater than 15 mm diagonal, e.g., 19-29 mm or more) simultaneously in one image.

Image processing unit 122 is configured to perform digital image reconstruction, e.g., via an image reconstruction algorithm 124, to provide three-dimensional (3D) and/or multicolor super-resolution imaging. Imaging processing unit 122 may alternatively perform analog optical image reconstruction and other processing algorithms (e.g., [43], [44], [45], [46], [47]).

Other configurations and functions may be incorporated, for example, and not limited to [48], [49], [50], [51], and [52].

Example system #2—Stationary sample system. As noted above, FIG. 1B shows the MSM system 100b configured to capture images of the sample by moving the projections of the diffraction-limited foci. In the example shown in FIG. 1B, the optic assembly 110 (shown as 110′) is configured to move (shown as direction 128) to provide a diffraction-limited multi-focal excitation pattern that is moving on a stationary sample (e.g., 116). In the example, the sample stage 114 may be configured to move, but the movement may be to provide a different view of a different portion of the sample and not necessarily to provide multiple captures of the diffraction-limited multi-focal excitation pattern at different positions for the same sample.

Example system #3. FIG. 1C shows the MSM system 100c configured to capture images of the sample using an alternative lens assembly. In the example shown in Fig. IC, the optics assembly 106 (shown as 106′) is configured with a first portion 106a and a second portion 106b to separately and individually direct the laser 103 (shown as 103a, 103b) from lasers 102 to the multilens array 108.

### Example Three-Dimensional Multifocal Scanning Microscopy (3D-MSM) System

FIGS. 2A shows an example 3D MSM system 100 (shown as 200a) configured to project a multifocal excitation pattern having one or more different wavelengths of light onto a sample plane (e.g., having the sample) while the sample is being scanned by a motorized stage and sensor to provide a 3D reconstructed image of the sample.

In the example shown in FIG. 2A, the exemplary system 200a includes a collimated laser source 102 (shown as 102a and 102b) configured to generate a collimated red laser and a collimated blue laser. The collimated laser beams 103 (shown as 103a, 103b) are propagated through the optics assembly 106 (shown as 106a) comprising a mirror 202, a dichroic mirror 204, lens 206a, 206b, and a spatial filter 208 (i.e., pinhole), to generate a combined laser beam 105 (shown as 105a).

In the optics assembly 106a, the collimated laser beam 105a is propagated through the multilens array 108 (shown as “MLA” 108a) to generate a multifocal excitation pattern 107. An example multilens array 108 is provided in FIG. 2C. The multifocal excitation pattern 107 is then propagated through an optics assembly 110 (shown as 110a) to generate diffraction-limited multi-focal excitation pattern 111 (shown as 111a) at a sample plane having the sample 116.

In the example shown in FIG. 2A, the optics assembly 110a includes a relay lens 210 (shown as “RL” 210), dichroic mirror 212 (shown as “DM” 212), and objective lens 214. In the optics assembly 110a, the generated multifocal excitation pattern 107 as diffraction-limited foci is directed through the relay lens 208 to the dichroic mirror 210 that then projects the diffraction-limited multi-focal excitation pattern 111a through the objective lens 214 at the sample plane of the sample 116. The fluorescent emissions 113 (shown as 113a) emitted from the sample 116 are then directed back through the objective lens 214 to the sensor array 120 (shown as “sCMOS” 120a). The sensor array 120a captures and stores images of the sample 116 at different scanning positions, e.g., as the sample 116 is being scanned.

The diffraction-limited multi-focal excitation pattern 111a (an example shown as 111a′) can be projected at the sample plane having a pitch d (e.g., d=0 μm, d=1 μm, d=2 μm, d=3 μm, d=4 μm, d=5 μm, d=6 μm, d=7 μm, d=8 μm, d=9 μm, d=10 μm) and angle θ (e.g., between 1° and 180°) relative to the scanning direction (e.g., 118). The sample 116 may be scanned for multiple scanning planes; each scanning plane (e.g., having a corresponding Z-across) has a scanning direction having two or more axes of directions or travel (e.g., along X-Y plane). In the example shown in FIG. 2A, a square multi-focal pattern is generated via a square patterned MLA (e.g., 108) that cumulatively covers the full sample field of view, encompassing both lateral dimensions. Other multi-focal pattern shapes may be employed, e.g., circular, rectangular, oval, among others. In the example shown in FIG. 2A, the multiple scanning planes Z are acquired at sampling plane Z₁ (216a) to sampling plane Zₙ (216b).

In some embodiments, to capture multi-focal images (emitted as fluorescence signals) of the sample 116, the motorized translational sample stage (i.e., XY stage) 114 underwent continuous scanning at a constant speed (e.g., 10 μm/sec, 20 μm/sec, 30 μm/sec, 40 μm/sec, 50 μm/sec). The continuous scanning may be synchronously coordinated with the camera acquisition at a capture rate (e.g., 100, 200, 300, 400, 500, 600 frames per second), e.g., via the controller (e.g., 104).

The sample 116 may be scanned along a scanning plane for the different scanning positions in the plane to provide multifocal illumination and acquisition across the full sample volume. After the scans for the current scanning plane are completed, the objective lens may be repositioned to move the focal plane of the diffraction-limited multi-focal excitation pattern 111a to the next scanning plane. The axial (e.g., z-direction) step size may be in increments of 100 nm, 110 nm, 120 nm, 130 nm, 140 nm, 150 nm, 160 nm, 170 nm, 180 nm, 190 nm, 200 nm. In some embodiments, the axial (e.g., z-direction) step size is less than 100 nm. In some embodiments, the axial (e.g., z-direction) step size is greater than 200 nm. In some embodiments, the axial (e.g., z-direction) step size is user-or program-definable.

The exemplary system 200a may be designed based on an epi-fluorescence microscope, image-scanning microscopy, among other microscopes or imaging systems described herein, or integrated into one.

### Example Multi-Color Multifocal Scanning Microscopy (multi-color MSM) System

FIGS. 2B shows an example multi-color MSM system 100 (shown as 200b) configured to project an interposed multi-color multifocal excitation pattern having two or more different wavelengths of light onto a sample plane (e.g., having the sample) while the sample is being scanned by a motorized stage and sensor to provide a multi-color reconstructed image of the sample.

In the example shown in FIG. 2B, the exemplary system 200b includes a collimated laser source 102 (shown as “488 nm” laser 102a′ and “647 nm” laser 102b′) configured to generate a collimated red laser and a collimated blue laser. The collimated laser beams 103 (shown as 103a, 103b) are propagated through the optics assembly 106 (shown as 106b), having a first optics portion 220a and a second optics portion 220b. The first optics portion 220a includes lens 222a, 222b, mirror 224, and dichroic mirror 226 to combine the beams 103a, 103b from the lasers 102a′, 102b′ and direct the combined beam 105 (shown as 105′) to the dichroic mirror 226, which directs the blue laser 105a′ to the multilens array 108 (shown as “MLA” 108b) while allowing the red laser 105b′ to be directed to the second optics portion 220b. The second optics portion 220b includes mirrors 228a, 228b to direct the red laser 105b′ to the multilens array 108b.

The blue laser 105a′ and red laser 105b′ are interposed at the multilens array 108b. to form the interposed multi-color multifocal excitation pattern 107 (shown as 107a′, 107b′). The multifocal excitation pattern 107a′, 107b′ is then propagated through an optics assembly 110 (shown as 110b) to generate diffraction-limited multi-focal excitation pattern 111 (shown as 111b) at a sample plane having the sample 116.

In the example shown in FIG. 2B, the optics assembly 110b includes a relay lens 210 (shown as “RL” 210), a dichroic mirror 212, a relay mirror 230, and an objective lens 214. In the optics assembly 110b, the generated interposed multifocal excitation pattern 107a′, 107b′ as diffraction-limited foci is directed through the relay lens 208 to the dichroic mirror 210 that then projects the diffraction-limited multi-focal excitation pattern 111b through the objective lens 214 at the sample plane of the sample 116. The fluorescent emissions 113 (shown as 113b) emitted from sample 116 are then directed back through the objective lens 214 to the sensor array 120 (shown as “CAM” 120b). The sensor array 106b captures and stores images of the sample 116 at different scanning positions, e.g., as the sample 116 is being scanned.

The diffraction-limited multi-focal excitation pattern 111b can be projected at the sample plane having a pitch d (e.g., d=0 μm, d=1 μm, d=2 μm, d=3 μm, d=4 μm, d=5 μm, d=6 μm, d=7 μm, d=8 μm, d=9 μm, d=10 μm) and angle θ (e.g., between 1° and 180°) relative to the scanning direction (e.g., 118). The sample 116 may be scanned for one or more scanning planes each in a scanning direction having two or more axes of directions or travel (e.g., along X-Y plane). The multi-focal pattern shapes may be square, circular, rectangular, or oval, among others. In some embodiments, multiple scanning planes Z are acquired at sampling plane Z₁ to sampling plane Zₙ, e.g., as described in relation to FIG. 2A, e.g., to provide a 3D multi-color reconstructed image.

In some embodiments, to capture multi-focal images (emitted as fluorescence signals) of the sample 116, the motorized translational sample stage (i.e., XY stage) 114 underwent continuous scanning at a constant speed (e.g., 10 μm/sec, 20 μm/sec, 30 μm/sec, 40 μm/sec, 50 μm/sec). The continuous scanning may be synchronously coordinated with the camera acquisition at a capture rate (e.g., 100, 200, 300, 400, 500, 600 frames per second), e.g., via the controller (e.g., 104).

The exemplary system 200b may be designed based on an epi-fluorescence microscope, image-scanning microscopy, among other microscope or imaging systems described herein, or integrated into one.

### Example MSM Image Reconstruction

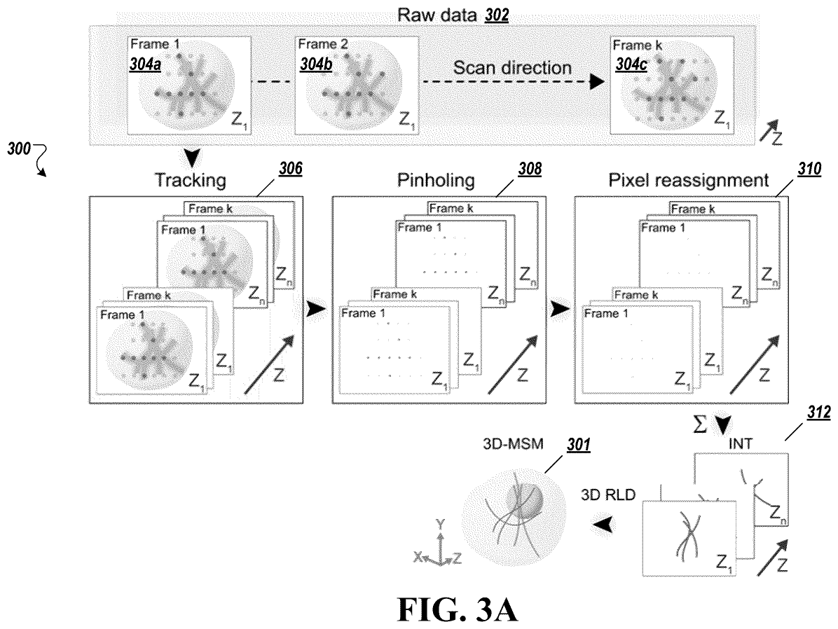

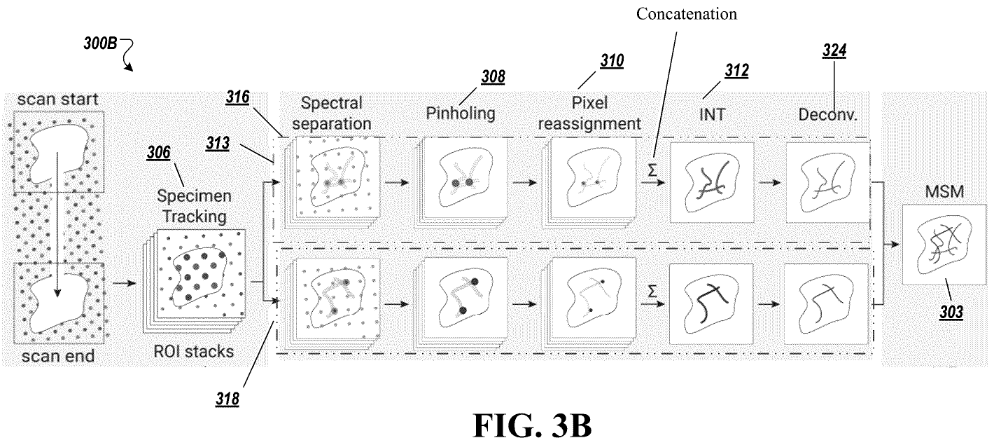

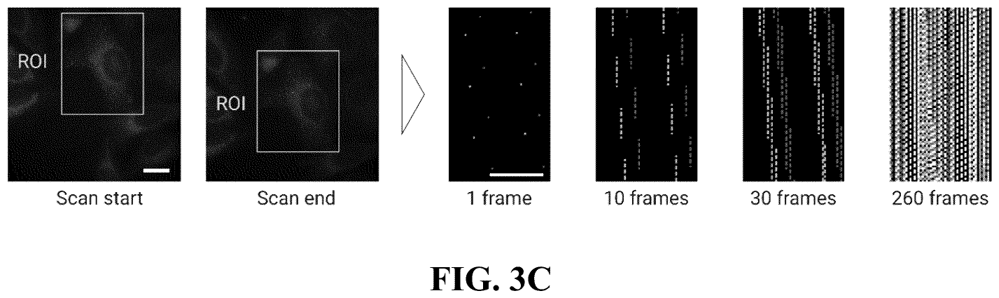

3D MSM Image Reconstruction. FIG. 3A shows an example image reconstruction process 300a to generate a 3D MSM reconstructed image 301. The image reconstruction process 300a may employ images 121 (shown as “Raw data” 302 comprising “Frame 1” 304a, “Frame 2” 304b, . . . “Frame k” 304c) captured or scanned by a multi-color MSM system, e.g., as described in relation to FIG. 2B.

The scanned multi-focal images may be first stabilized (306), e.g., through a linear tracking plot operation that adjusts the image for a motion of the stage along the scanning direction on a frame-by-frame basis for each set of acquired scanning plane Z.

At step 308, a digital pinhole mask (e.g., σ=97.5 nm) is applied to reject the out-of-focus light from each multi-focal excited frame to generate a pinholed frame. The pre-calibrated pinhole mask (σ=97.5 nm, i.e., 1.5× effective pixels for an example sampling) may be used.

At step 310, pixel reassignment is applied to effectively halve the size of each focus on each frame of the stack of frames to generate a set of intermediate frames. The pixel assignment can improve the resolution (e.g., 1.4×) compared to the corresponding wide-field frame [19].

At step 312, a 3D deconvolution operation is performed to the stacks of intermediate reassigned pixels in the frames of each scanning layer to generate the reconstructed 3D MSM image 301. It has been observed that the reconstructed 3D MSM image 301 can have a full 2×resolution enhancement in all three dimensions as compared to ISM systems (e.g., 3D wide-field (WF) ISM systems).

Multicolor Image Reconstruction Process. FIG. 3B shows an example image reconstruction process 300b to generate a multi-color MSM reconstructed image 303. The multi-color image reconstruction process may also include image tracking 306 and digital pinhole 308, pixel reassignment 310, and image deconvolution 312, similar to that described in relation to FIG. 2A but for each spectral channel.

The scanned multi-focal images may be first stabilized (306), e.g., through a linear tracking plot operation that adjusts the image for a motion of the stage along the scanning direction on a frame-by-frame basis for each set of acquired scanning plane Z. Specifically, a region of interest (ROI) was selected, and the motion of the multifocal image was tracked based on the displacement of the stage per acquisition frame (i.e., frame-to-frame basis), which subsequently generated a stack of frames (referred to as ROI stack). Each frame in the stack can be adjusted via flat-field correction (i.e., fit into a linear tracking plot) according to a pre-calibrated illumination intensity envelope.

FIG. 3C shows an example of multicolor scanning. The sample is continuously scanned by a motorized stage, which results in the continuous translation of the region of interest (ROI) during the scanning procedure. Correspondingly, the coordinates of the multifocal excitation for each wavelength follow the motion of the region of interest in every frame. Summing the trajectory of the multifocal excitation displays the coverage of the illumination on the sample plane. The sample plane is considered fully scanned when the summed multifocal excitation covers the entire region of interest.

Referring to FIG. 3B, at step 307, each frame is separated via a spectral separation operation. The coordinates of the excitation foci (acquired by calibration of multifocal excitation patterns) on the frame are provided into separate spectral channels 316 and 318.

At step 308, a digital pinhole mask (e.g., σ=97.5 nm) is applied to each of the spectral channels 316, 318, according to the pre-calibrated array of the excitation foci, to reject the out-of-focus light from each multi-focal excited frame to generate a pinholed frame. The pre-calibrated pinhole mask (σ=97.5 nm, i.e., 1.5×effective pixels for an example sampling) may be used.

At step 310, pixel reassignment is applied to each of the spectral channels 316, 318 to effectively halve the size of each focus on each frame of the stack of frames to generate a set of intermediate frames. That is, the spectral channels are downscaled by locally contracting them by a factor of two and reassigning them to a scaled image of the halved pixel size of 32.5 nm [14′], [20′], [21′].

At step 320, for each spectral channel 313 and 315, the pixel-reassigned frames are concatenated (i.e., summed up) to generate an intermediate image (referred to as INT).

At step 322, the resolution-enhanced (e.g., √2×) intermediate frames are generated by overlaying these pixel-reassigned images, followed by a blind deconvolution operation. The process has been shown to provide a 2× resolution improvement over the diffraction limit of the corresponding wide-field frame. The resolution-enhanced intermediate frames from spectral channels 316 and 318 were then merged to form the final multicolor super-resolution image 303.

The blind convolution operation may employ a numerical point spread function (PSF), which describes the response of a focused optical imaging system to a point source or point object. Indeed, the interposed multicolor excitation pattern allows for the simultaneous acquisition of multiple spectral channels without ambiguity, which may be separately processed with the prior calibration and the above procedures.

3D and Multi-color Reconstruction. 3D and Multi-color MSM images can be performed using the multi-color MSM system 200b as described in relation to FIG. 2B when configured to acquire the multiple scanning planes of the sample as described in relation to FIG. 2A. 3D and multi-color reconstruction share image post-processing operations, including pinholing, and pixel reassignment. While 3D reconstruction (FIG. 3A) involves an additional step of 3D deconvolution, multi-color reconstruction (FIG. 3B) employs spectral separation. To perform 3D and Multi-color reconstructions, planar image reconstruction can be performed per the pipeline of multi-color reconstruction, e.g., as described in FIG. 3B, with an additional step of 3D deconvolution to achieve multicolor 3D super-resolution imaging, as described in relation to FIG. 3A.

### Example Calibration of Multifocal Excitation Patterns

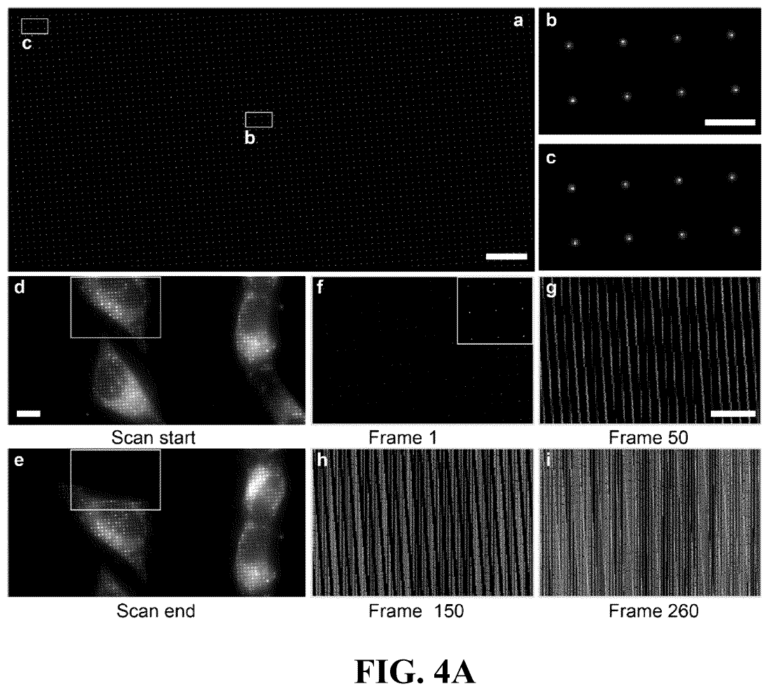

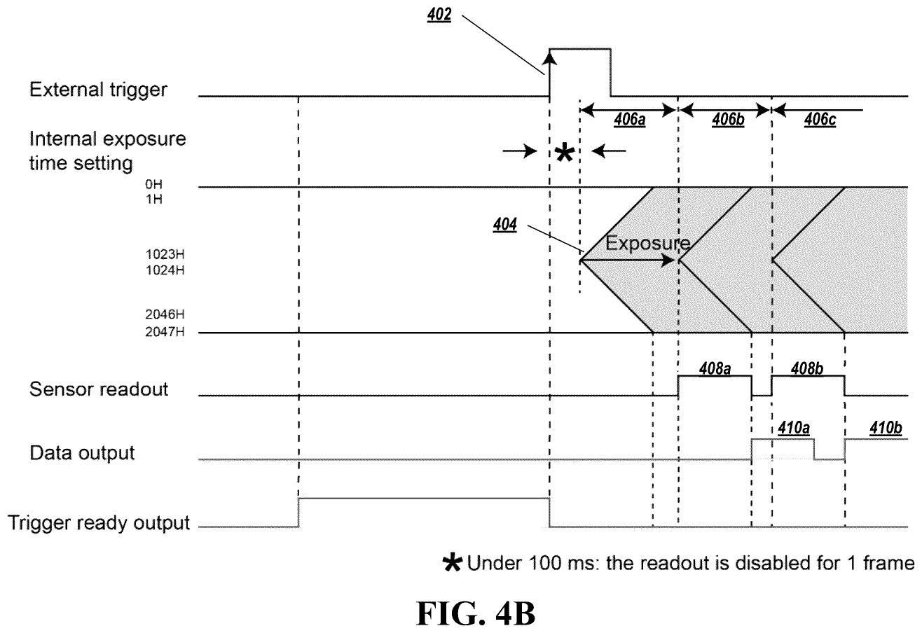

FIG. 4A shows an example calibration process for the foci patterns. Calibration of multi-focal excitation patterns can be performed using a cover glass coated with uniformly distributed fluorescent dyes to acquire coordinates of the excitation foci.

The calibration process can identify the precise location of each illumination spot across the field of view. To calibrate the positions of the foci spots, a slide containing a uniform distribution of fluorescent dyes can be imaged, e.g., by taking and averaging a series of images of the fluorescent dyes. Then, position of the local maxima (maximum peak) (e.g., (b) and (c)) can be employed to generate a map of the focal spots (i.e., coordinates) as shown in FIG. 4A. Once the system is calibrated and the desired sample is mounted, the stage can scan uniformly across the sample, e.g., in the lateral direction and raster scans in the axial directions, from start position (d) to end position (e). In an example, a scan may acquire approximately 260 frames for each Z-layer to ensure full coverage of the sample. (f), (g), (h), and (i) show a general summation of the coordinates of the multifoci excitation from one frame to the other.

### Example Control of Camera External Triggering Mechanism

FIG. 4B shows an example camera external triggering mechanism to control the image acquisition of the exemplary system, e.g., of the MSM system of FIGS. 2A and 2B. In FIG. 4B, the yellow-colored portion represents the exposure condition. When imaging thick samples, fast acquisition can reduce or remove photobleaching.

In the example of FIG. 4B, in the “start trigger” camera mode (indicated as rising edge 402) used for image acquisition, an external trigger from the XY stage can be used as the input to the camera. The XY stage (i.e., motorized stage) set in SCAN mode, functioning as the leading entity and triggering the camera, can initiate high-speed acquisition (e.g., 200 HZ) as the stage moves uniformly along the X-axis. When the camera receives the input signal, it can switch to a free running mode and run at maximum speed, and the camera exposure 404 can start at the same time.

While the stage is moving, the camera may be exposed to various regions of the sample for specific durations 406a, 406b, and 406c. During each duration 406b and 406c, the camera can capture an image of a corresponding region of the sample to provide sensor readouts 408a and 408b, respectively. At the end of each sensor readout 408a and 408b, the images captured by the camera are reconstructed and produced as super-resolution images to provide data outputs 410a and 410b, respectively.

When the stage finished moving for the specified distance, it sent another time-to-live (TTL) signal to the camera to stop acquiring an image. In the meantime, the X-Y stage can move back to its original position while the Z stage moves up in Z. The raster scan can then continue until it reaches the specified axial distance. The approach can be used to acquire super-resolution images at fast speeds when imagining thick samples.

### Example Photofluidic Multi-Focal Scanning Microscope

The sample stage (e.g., 114) can be integrated into or coupled to a microfluidic device or flow chamber of a photofluidic microscope. Photofluidic microscope combines the principles of optics and microfluidics to enable the imaging of biological samples with high spatial and temporal resolution. Microfluidic channels can be used to control the flow and positioning of biological samples in front of a high-resolution optical microscope, e.g., to perform high-speed, high-resolution imaging of living cells in their native environment.

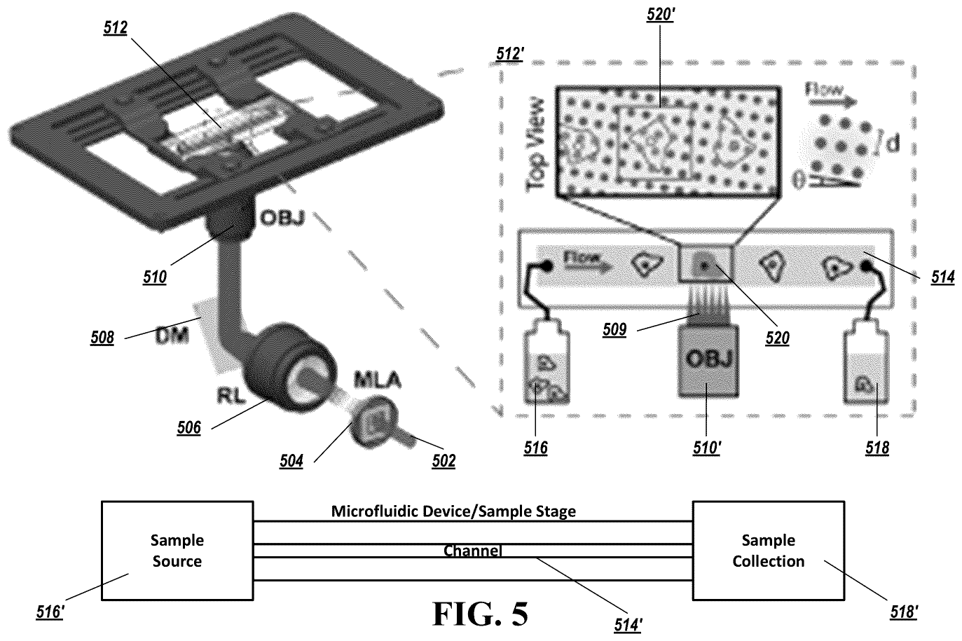

FIG. 5 shows an example sample stage configuration of an MSM system (e.g., 100) configured as a photofluidic microscope. In the example shown in FIG. 5, a laser beam 502 propagates through an MLA 504 to generate a multifocal excitation pattern. The multifocal excitation pattern propagates through an optics assembly (not shown), including a RL 506, a DM 508, and an objective lens (OBJ) 510 (also referred to as 510′) to project a diffraction-limited multifocal excitation pattern 509 onto a sample stage 512 (also referred to as microfluid device). There may be a small gap d between each focus in the pattern 509.

The top view 512′ of the sample stage 512 has a sample source 516 (also referred to as 516′) connected to a sample collection 518 (also referred to as 518′) via a channel 514 (also referred to as 514′). A fluidic sample 520 (also referred to as 520′) flows from the reservoir 516 to the waste reservoir 518 through the channel 514. When flowing through the channel 514, the sample 520 may be exposed to the diffraction-limited multifocal excitation pattern 509 generated by the objective lens 510′. There may be a small tilted angle between the sample 520′ and the direction of the pattern 509.

### Experimental Results and Additional Examples

A study was conducted to develop a multifocal scanning microscopy (MSM) and multi-color system and method for super-resolution imaging of cells and tissues with reduced instrumental complexity. In one configuration, the exemplary MSM system of the study was used to produce 3D super-resolution images of cells and tissues. In another configuration, the exemplary MSM system of the study was used to produce multicolor super-resolution images of cells and tissues.

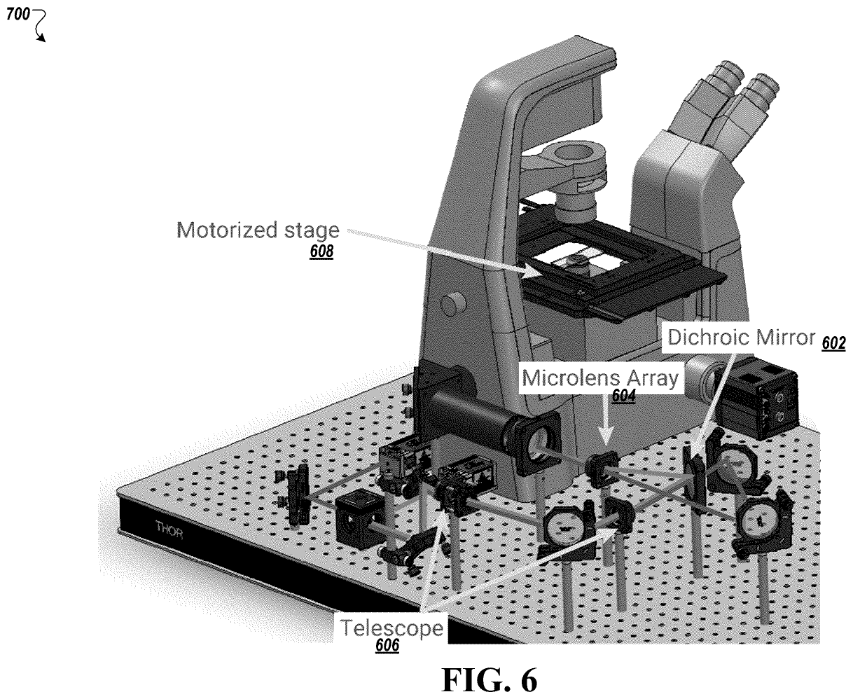

FIG. 6 shows an example MSM prototype system including a dichroic mirror (DM) 602, a microlens array (MLA) 604, a telescope (TS) 606, and a motorized stage 608. In FIG. 6, the combined laser beams (red and blue) from the laser sources (not shown) were expanded by the telescope 606 and transmitted by a dichroic mirror 602 to the microlens array 604 to generate a multifocal excitation pattern (not shown). The microlens array directed the multifocal excitation pattern through an objective lens (not shown) to generate a diffraction-limited multifocal excitation pattern on a sample on the motorized stage 608. The diffraction-limited multifocal excitation pattern on the sample remained stationary, and the motorized stage 608 scanned the sample in some directions.

### Experimental Results of 3D MSM System

Sample preparation. The study prepared some samples (e.g., cells) and equipment (e.g., microscopes) to evaluate the 3D MSM system.

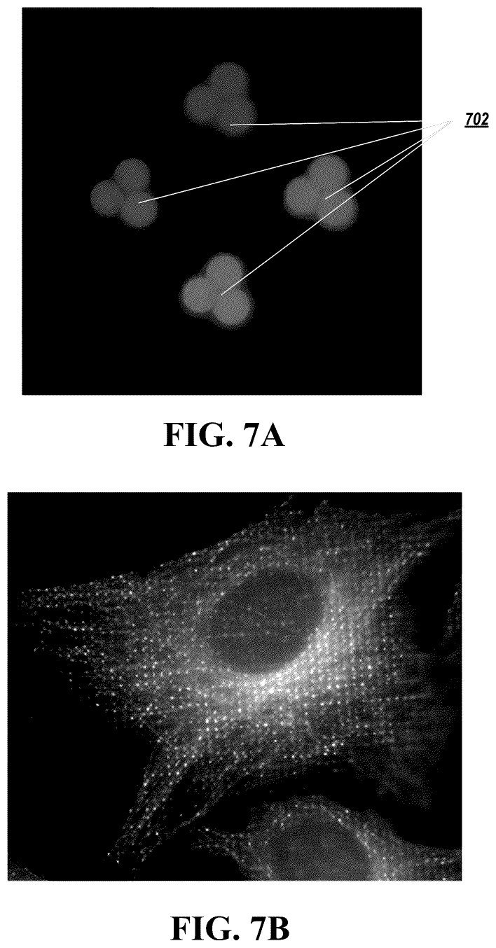

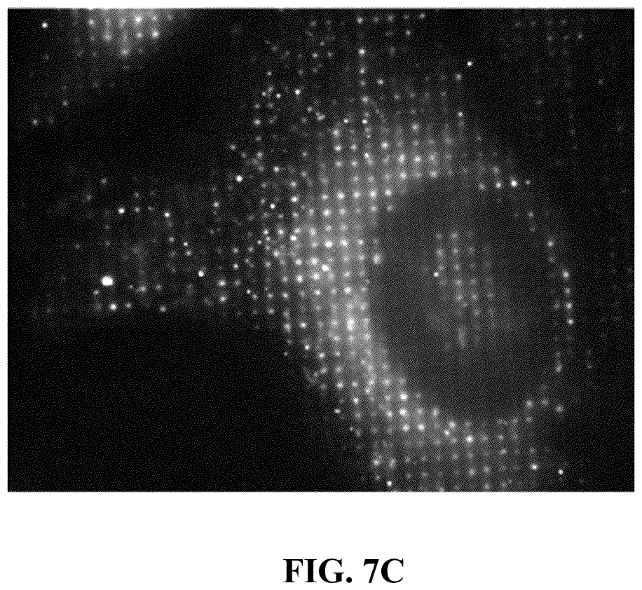

FIG. 7A shows an example 100-nm TetraSpeck microsphere fluorescent beads 702 (e.g., Invitrogen T7279). The study performed resolution measurements using the 100-nm TetraSpeck microsphere fluorescent beads 702. The beads were diluted in clear phosphate-buffered saline (PBS) (e.g., #21-040-CM Corning PBS) for sparse distribution. To demonstrate the structural resolution capability of the exemplary MSM system, the study mixed a 1 μm TetraSpeck microspheres (e.g., Invitrogen T7282) (not shown) with a 4 μm TetraSpeck microspheres (e.g., Invitrogen T7283) (not shown) to serve as a marker for better tracking. The mixture of the 1 μm and 4 μm beads were both diluted in PBS for sparse distribution.

FIG. 7B-7C show examples HeLa cells (i.e., immortalized cells) used in the experiment. Specifically, FIG. 7B shows example microtubules in bovine pulmonary artery endothelial (BPAE) cells, a type of Hela cells, and FIG. 7C shows an example combination of peroxisome and mitochondria, another type of HeLa cells.

The study cultured HeLa cells (e.g., Sigma-Aldrich #93021013) in 35 mm FluoroDish (e.g., World Precision Instruments #FD35-100) in Dulbecco's modified Eagle medium (DMEM) (e.g., #10-013-CV Corning DMEM) with 10% fetal bovine serum (FBS) (e.g., #35-011-CV Corning FBS) and 1% Penicillin-Streptomycin (Pen-Strep) (e.g., #15140122ThermoFisher Pen-Strep) at 37° C. and in a 5% CO₂ atmosphere. On the day of imaging, the study fixed cells fixed with 0.3% glutaraldehyde in extraction buffer, incubating for 1 minute at 37° C. The extraction buffer consisted of 10 mM MES, 150 mM NaCl, 5 mM EDTA, 5 mM glucose, 5 mM MgCl₂, and 0.25% Triton X100 in ultra-pure water. The buffer of the cells was then switched to 2% glutaraldehyde in cytoskeleton buffer at room temperature for 10 minutes. The cytoskeleton buffer was the extraction buffer without the Triton X-100. The study washed the cells with blocking/permeability (b/p) solution for 5 minutes, 3 times. The b/p solution consisted of 2.5% (weight:volume) bovine serum albumin (BSA) and 0.1% Triton X-100 in PBS. Then, the study added the primary antibody that targets beta-tubulin to the cell dish with 2 mL of b/p solution at a concentration of 2 μg/mL (e.g., ThermoFisher #32-2600). The study placed the cell dish inside a humidified chamber at room temperature for 1 hour.

After primary antibody tagging, the study washed the cell dish with b/p solution 3 times, for 5 minutes each time. Then cells were co-labeled with 2 μg/mL of Goat anti-Mouse IgG conjugated with Alexa Fluor Plus 488 (e.g., ThermoFisher #A32723) and 2 μg/mL of Goat anti-Mouse IgG conjugated with Alexa Fluor 647 (e.g., ThermoFisher #A-21235). The staining took place inside a humidified chamber at room temperature for 1 hour. After secondary antibody labeling, the study washed the cell dish with b/p solution 3 times for 5 minutes each and sequentially washed with PBS twice. The study then stored the sample at 2 mL of PBS solution for imaging. Although the microtube was co-labeled with a red and blue fluorophore, only a blue laser was used to excite the sample.

The study also prepared samples for mitochondrial imaging from HeLa cells as well. To prepare the staining solution, the study incubated the cells in 3 mL prewarmed (37° C.) modified DMEM one day prior to imaging. On the day of imaging, 0.6 μL of 1 mM MitoTracker Deep Red FM stains (e.g., ThermoFisher #M22426) was added to the growth medium and incubated for an additional 30 minutes until they reached the desired confluency. After staining, the growth medium was removed, and the cells were washed twice with clear Hank's balanced salt solution (HBSS) (e.g., #21-021-CV Corning HBSS). Finally, the study fixed the cells with a pre-prepared 4% paraformaldehyde (PFA, diluted from 16% PFA with PFA:PBS:ultrapure water in 1:2:1 ratio, Electron Microscopy Sciences) for 12 minutes at room temperature. After fixation, the study rinsed the cells twice with PBS and stored in 2.5 mL of PBS solution.

The mouse kidney section for the optical sectioning demonstration was imaged from a prepared immunostained fluorescent slide (Invitrogen FluoCell Prepared Slide #3). The slide contained a 16 μm cryostat section of mouse kidney stained with Alexa Fluor 488 wheat germ agglutinin (i.e., W-11261), Alexa Fluor 568 phalloidin (i.e., A-12380) and DAPI (i.e., D-1306).

System Design. The 3D MSM system employed in the study incorporated 488-nm and 647-nm laser sources (e.g., Coherent OBIS laser source), a motorized translational sample stage (e.g., Applied Scientific Instrumentation MS-2000 Flat Top XY stage), a first optics assembly including a relay lens (RL), a dichroic mirror (DM), and an objective lens (OL) (e.g., Nikon CFI Plan Apochromat Lambda 100× Oil), and a microlens array (MLA) (e.g., RPC Photonics MLA, S100-f4-A). The system also incorporated a sensor (e.g., Hamamatsu ORCA-Flash 4.0 sCMOS camera with pixel size=6.5 μm) that was coupled with the first optics assembly.

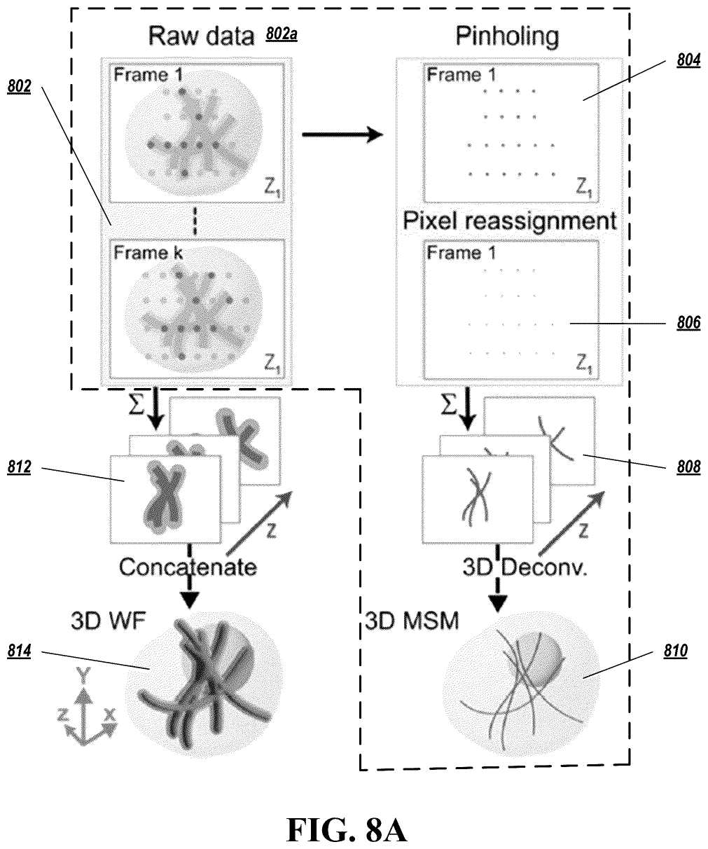

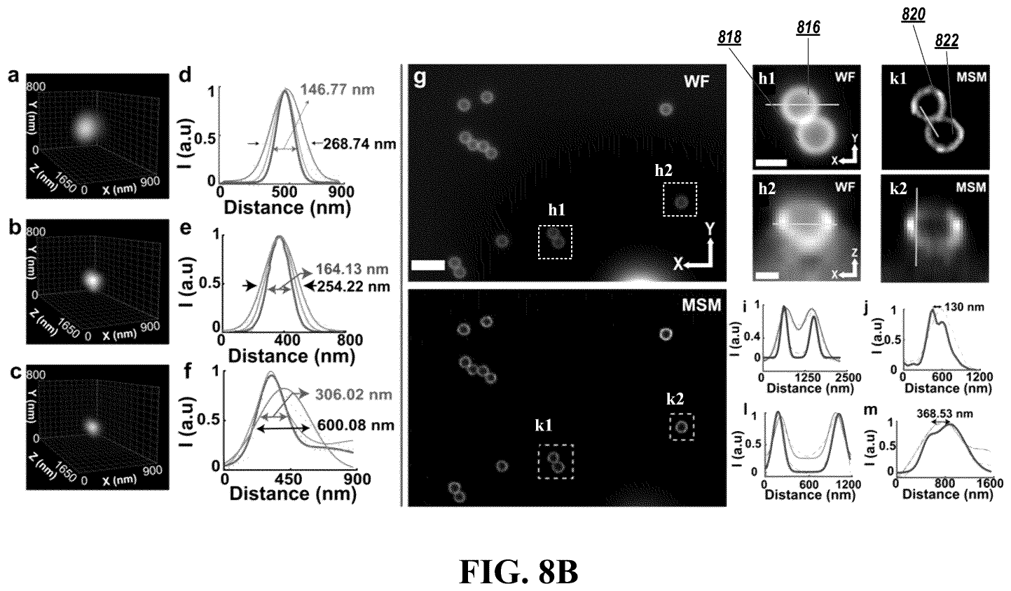

Experimental 3D MSM and WF image reconstruction. The study conducted an experiment on WF and 3D MSM image reconstruction and compared the quality of the reconstructed images produced from the two processes. FIG. 8A shows example image reconstruction processes for the 3D MSM system and the WF system. The 3D MSM image reconstruction process is highlighted by a dashed box.

Specifically, the 3D MSM and the WF reconstruction processes share step 802, wherein each scanned multi-focal image was stabilized through a linear tracking plot that monitored the uniform motion of the stage along the scanning direction on a frame-by-frame basis, which generated a stack of frames 802a (i.e., raw data).

At step 804, a digital pinhole mask was utilized to reject the out-of-focus light from each multi-focal excited frame to generate a pinholed frame.

At step 806, pixel reassignment was employed to effectively halve the size of each focus on each frame of the stack of frame, obtaining an intermediate frame of 1.4× resolution improvement compared to the corresponding wide-field frame.

At step 808, a 3D deconvolution was implemented to the stacks of the intermediate pixel-reassigned frames, producing a 3D MSM image 810 with full 2×resolution enhancement in all three dimensions. The 3D MSM image 810 had better resolution than a wild-field (WF) image 814 because the WF image 814 was simply a concatenation of the frames in the stack of frames 802a, wherein each frame 812 did not have resolution enhancement as those at step 808.

System characterization. To evaluate 3D-MSM, the study utilized a 488-nm laser to image sub-diffraction-limited 100-nm fluorescent beads with peak emission at 515 nm.

FIG. 8B shows examples of wide-field (WF) imaging and 3D MSM imaging of phantom samples for system characterization. Specifically, subpanel (a) shows wide-field (WF), pinholed and pixel-reassigned intermediate (INT), and MSM images of one microsphere at a focal plane of 100-nm green fluorescent beads (peak emission wavelength:515 nm). Subpanel (b) shows corresponding 2D Gaussian fitting of the images of the microsphere in 8a that exhibit a Full Width at Half Maximum (FWHM) value of 268.74 nm, 189.28 nm, and 146.77 nm, respectively. Subpanels (c) and (c) WF, INT, and MSM of the images in subpanel (a) in the XZ direction and YZ direction, respectively. Subpanels (d) and (f) show corresponding 2D Gaussian fits of the images in subpanel (c) and (c), respectively, indicating FWHM values of 600.08 nm, 437 nm, and 306.02 nm for subpanel (d), and 597.6 nm,437.1 nm, and 313.5 nm for subpanel (f). Additionally, an FWHM value indicates an intensity distribution at a point where the intensity is at its highest. An FWHM may determine the width of a spectral line or a peak-to-peak distance in a spectral line of a microsphere, which is a good measure of resolution in microscopy.

In FIG. 8B, subpanel (g) shows WF and MSM images of a surface-stained 1 μm fluorescent microsphere (emission peak of 680 nm) at the focal plane. Subpanels (h1) and (h2) show zoomed-in regions h1 and h2 from the WF image in subpanel (g). Subpanel (i) shows cross-sectional profiles along the yellow line in subpanel (h1) demonstrating FWHM values (i.e., peak-to-peak distances) of 452.27 nm and 556.80 nm for microspheres 816 and 818, respectively. Subpanel (l) shows a cross-sectional profile along the yellow line in subpanel (h2), demonstrating an FWHM value (i.e., peak-to-peak distance) of 882.76 nm. Subpanel (j) shows cross-section profiles along the yellow line in subpanel (k1) demonstrating FWHM values (i.e., peak-to-peak distances) of 193.96 nm and 230.68 nm for microspheres 820 and 822, respectively. Subpanel (m) shows a cross-sectional profile along the yellow line in subpanel (k2), demonstrating an FWHM value (i.e., peak-to-peak distance) of 368.53 nm.

In FIG. 8B, subpanel (a)-subpanel (f) show super-resolution images displaying improved contrast and resolution in all three dimensions in comparison with their corresponding wide-field images. In particular, 3D-MSM yielded FWHM measurements (i.e., the width of a spectral line) of ˜140 nm and 310 nm in the microsphere images with 3D-MSM in the lateral and axial dimensions, respectively. The results showed consistency with the predicted respective resolution doubling (˜120 nm and 300 nm) convolved with the 100-nm profile of the phantom structure, compared with 268 nm and 600 nm as measured in the wide-field images as shown in subpanel (d) and subpanel (f). Furthermore, the study imaged surface-stained 1-μm fluorescent microspheres, which revealed enhanced optical sectioning and resolution of the hollow phantom structures. Nearby microspheres as close as 130 nm in the lateral dimension may be well-resolvable using 3D MSM. Significant enhancement was also discernible in the axial resolution, as shown in the cross-sectional image of a single microsphere in subpanel (k2). This was further corroborated by the quantitative measurement of distances as small as approximately 369 nm in the axial direction.

Imaging microtubules in mammalian cells. The study also imaged immune-stained microtubules in bovine pulmonary artery endothelial (BPAE) using a 3D MSM system to demonstrate its super-resolution imaging of biological samples.

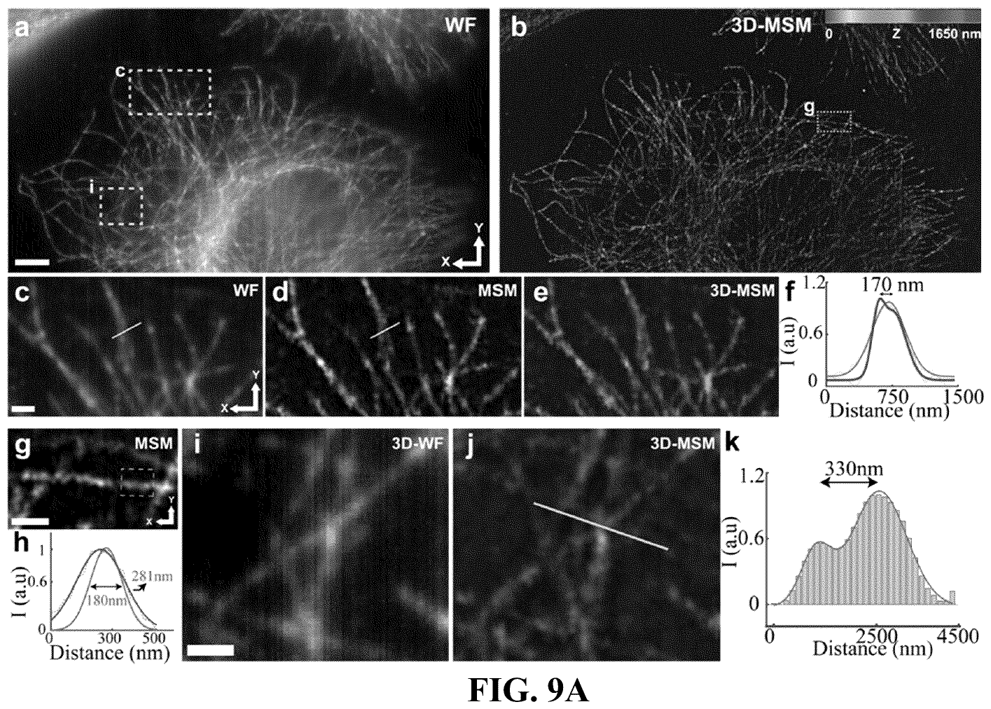

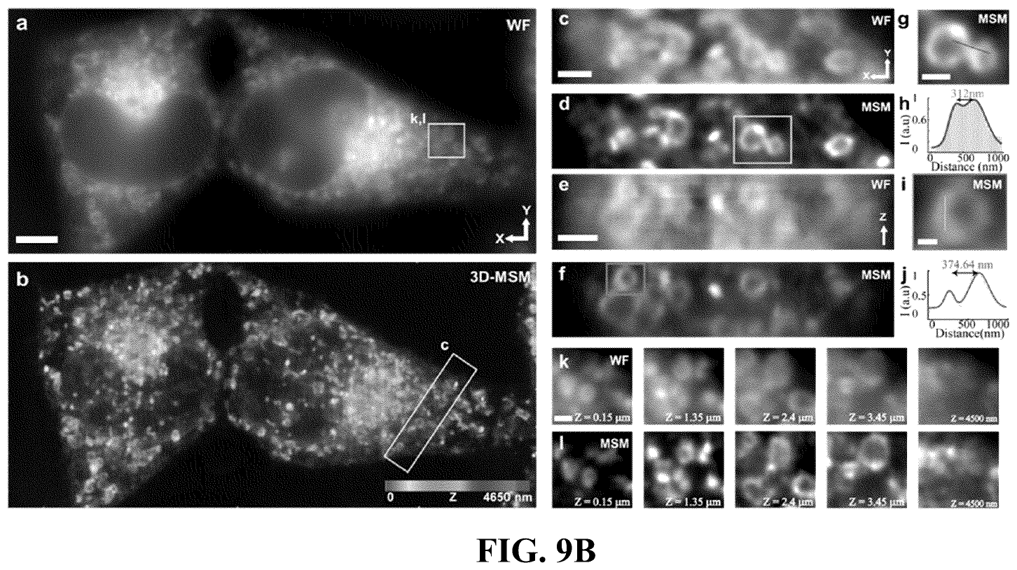

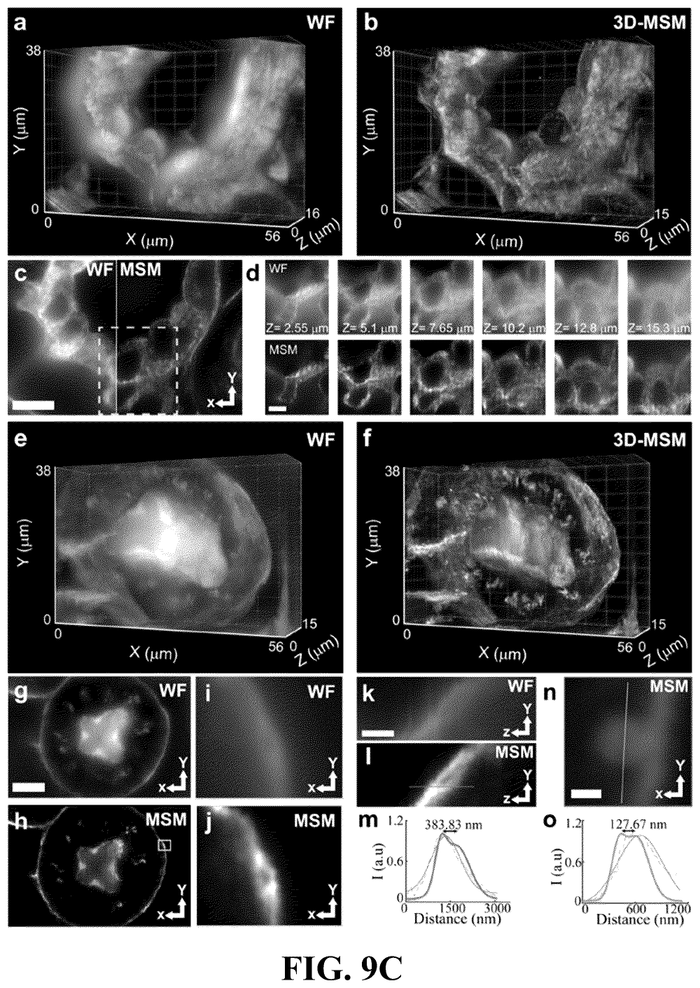

FIG. 9A shows example images of the microtubules in BPAE cells generated by a wide-field microscopic system and the exemplary 3D MSM system. Specifically, subpanel (a) shows a widefield image of a microtubule using a WF microscopic system. Subpanel (b) shows a 3D image of a microtubule using a 3D MSM system. Subpanels (c), (d), and (e) show a wide-field image, non-3D MSM image, and 3D MSM image of the yellow box c in subpanel (a), respectively. Subpanel (f) shows a comparison of microtubule filament separation distance (i.e., peak-to-peak distance, FWHM) of the yellow line in subpanel (c) and subpanel (d). Subpanel (h) shows a measurement of microtubule filament separation distance of 180 nm acquired from the non-3D MSM image (subpanel d). Subpanel (k) shows a measurement of microtubule filament separation distance of 330 nm along the yellow line in the 3D MSM image (subpanel j).

In FIG. 9A, the 3D MSM image (subpanel b) demonstrated improved contrast and resolution of subcellular details compared to the WF image (subpanel a). As shown in subpanels (c)-(f), the super-resolution images revealed the sub-diffraction-limited tubular structures separated as close as 170-180 nm in the lateral dimension. In addition, as shown in subpanels (f) and (h), when the study used 3D-MSM, individual filaments exhibited consistent FWHM values of 170-180 nm, consistent with the theoretical prediction of the width of immuno-stained microtubules (50-60 nm) [24], convolved with the super-resolution (150-160 nm) identified in the 3D-MSM images. Furthermore, in contrast to scanning wide-field stack images, the super-resolution images displayed substantially enhanced resolution of 3D cytoskeletal structures, as shown in subpanel (i) and subpanel (j). The microtubular filaments separated by ˜330 nm (shown in subpanel (k)) along the axial direction may be well resolved, suggesting an over two-fold resolution improvement compared to the sectioning ability of wide-field microscopy.

Imaging mitochondria in mammalian cells. The study used a 3D-MSM system to image MitoTracker-labeled mitochondria in Hela cells.

FIG. 9B shows WF and 3D-MSM images of the MitoTracker-labeled mitochondria in HeLa cells generated. Specifically, subpanel (a) shows a 2D wide-field image of mitochondria at the focal plane. Subpanel (b) shows a maximum intensity projection of mitochondria across all z-layers, where each color represents a different z-layer. Subpanels (c) and (d) compare the wide-field and MSM 2D section from the yellow region c shown in subpanel (b). Subpanels (e) and (f) show a comparison of the wide-field and MSM image of a region in subpanel (c) across all z-layers. Subpanel (g) shows a zoomed-in region of the yellow box in subpanel (d). Subpanel (h) shows a cross-sectional plot along the red line in subpanel (g), demonstrating the ability to achieve a 2D separation between two structures as small as 312 nm using 3D-MSM. Subpanel (i) shows a zoomed-in view of the green box in subpanel (f) across z. subpanel (j) shows a cross-section measurement along the yellow line of the structure in subpanel (i), resulting in a z-measurement of 374.64 nm. Subpanels (k) and (l) illustrate the yellow region of mitochondria at multiple z-layers in the WF image and MSM image, respectively, highlighting the capability of MSM to capture 3D information of the sample.

Unlike the wide-field images that displayed blurry mitochondrial structures due to limited optical sectioning and resolution, the 3D-MSM system delineated intricate structures with higher clarity across a substantial cellular volume, as shown in subpanel (a) and subpanel (b). The 3D super-resolution images unveiled the delicate mitochondrial reticulum tubules, which were generally measured at 300-400 nm when observed with a conventional wide-field microscope, as shown in subpanel (c) and subpanel (e). In particular, closely associated mitochondrial components, including their individual hollow profiles, were distinguishable in all three dimensions as shown in subpanels (d), (f), and (j), which indicated an enhancement of over 2× in resolution with 3D-MSM, in comparison to the diffraction limit (>600-800 nm). Additionally, such improvement maintained its volumetric consistency while navigating through multiple z-layers, spanning a depth range of over 4 μm within the cells, as shown in subpanel (k) and subpanel (l).

Imaging mouse kidney tissue. Previous microscopy methods may not effectively visualize subcellular structures within tissue samples (e.g., mouse kidney tissue) due to limitations in optical sectioning, contrast, and 3D resolution. The study used the 3D-MSM system to image an extensive volume of a mouse kidney tissue sample (ThermoFisher F24630). The sample, a cryostat section of a mouse kidney, was stained with Alexa Fluor 488-conjugated WGA (wheat germ agglutinin) lectin. With the rapid scan and high SNR of the 3D-MSM system, to the study continuously captured the entire 16-um thick tissue section within a span of minutes with no observable photobleaching.

FIG. 9C shows WF and 3D MSM images of different sections in a 16 μm-thick mouse kidney piece. Specifically, subpanels (a) and (b) show wide-field (WF) and 3D MSM images of a section in the mouse kidney piece, respectively. Subpanel (c) shows a representative image of a single layer from the WF and 3D MSM image stack. Subpanel (d) shows multiple Z-layer images of a yellow boxed region in subpanel (c) from the WF (top) and MSM (bottom) stack. Subpanels (e) and (f) show WF and 3D MSM images of another section of the mouse kidney piece, respectively. Subpanels (g) and (h) show WF and MSM images of a single Z-layer of the volume shown in Subpanels (e) and (f), respectively. Subpanels (i) and (f) show zoomed-in WF and MSM images of a yellow-boxed region in subpanel (h). Subpanels (k) and (l) show the WF and MSM images of a cross-sectional view along the YZ direction in subpanels (i) and (j), respectively. Subpanel (m) shows a cross-sectional profile along the blue line in subpanel (i) demonstrating the ability to separate structures separated by 383.83 nm in the axial direction. Subpanel (n) shows a zoomed-in region of the red box in subpanel (h), and subpanel (o) shows a cross-sectional profile along the orange line in subpanel (n) showing the ability to resolve structures laterally separated by 127.67 nm.

In FIG. 9C, in contrast to wide-field images, 3D-MSM allows for discerning high-contrast patterns of cellular layers, with cell boundaries sharply delineated as shown in subpanels (a), (b), (e), and (f). In particular, 3D-MSM images exhibited substantially enhanced glomerular and renal tubular components within the mouse kidney. Subpanels (m)-(o) demonstrate the ability of 3D-MSM to render volumetric images and perform optical sectioning, which provided the recovery of high-SNR axial stacks and offered a two-fold enhancement in the resolution of subcellular structural variations across both lateral and axial dimensions, ranging from 120-130 nm and 300-400 nm, respectively.

### Experimental Results of Multicolor MSM System

Sample preparation. The study performed multicolor imaging of biological samples using Hela cells (e.g., Sigma-Aldrich #93021013). The study cultured the cells in 35 mm FluoroDish (World Precision Instruments #FD35-100) in Dulbecco's modified Eagle medium (Corning DMEM, Corning #10-013-CV) with 10% fetal bovine serum (e.g., Corning FBS #35-011-CV) and 1% Penicillin-Streptomycin (e.g., ThermoFisher Pen-Strep #15140122,) at 37° C. and in a 5% CO2 atmosphere. On the day of imaging two-color microtubules, the study fixed the cells with 0.3% (volume: volume) glutaraldehyde in extraction buffer, incubating for 1 minute at 37C. The extraction buffer consisted of 10 mM MES, 150 mM NaCl, 5 mM EDTA, 5 mM glucose, 5 mM MgCl2, and 0.25% (volume:volume) Triton X-100 in ultra-pure water. The buffer of the cells was switched to 2% (volume:volume) glutaraldehyde in cytoskeleton buffer at room temperature for 10 minutes. The cytoskeleton buffer was the extraction buffer without the Triton X-100. The study then washed the cells with blocking/permeability (b/p) solutions for 5 minutes, 3 times. The b/p solution consisted of 2.5% (weight:volume) bovine serum albumin (BSA) and 0.1% (volume:volume) Triton X-100 in PBS. Then, the study added the primary antibody that targets beta-tubulin to the cell dish with 2 mL of b/p solution at a concentration of 2 μg/mL (e.g., ThermoFisher #32-2600). The study placed the cell dish inside a humidified chamber at room temperature for 1 hour. After primary antibody tagging, the cell dish was washed with b/p solution 3 times, 5 minutes each time. Then, the study labeled the cells with 2 μg/mL of Goat anti-Mouse IgG conjugated with Alexa Fluor Plus 488 (e.g., ThermoFisher #A32723) and 2 g/mL of Goat anti-Mouse IgG conjugated with Alexa Fluor 647 (e.g., ThermoFisher #A-21235) to achieve two-color staining. The staining took place inside the humidified chamber at room temperature for 1 hour. After secondary antibody labeling, the cell dish was washed with b/p solution three times 5 minutes each and sequentially washed with PBS twice. The study finally stored the sample at 2 mL of PBS solution for imaging.

The study also performed peroxisome and mitochondria imaging with HeLa cells following the same cell culture protocol. Prior to the day of imaging, the study incubated the cells in a pre-warmed (37° C.) mixed solution containing 3 mL modified DMEM and 20 μL CellLight Peroxisome-GFP (e.g., ThermoFisher #C10604). The GFP was expressed on the peroxisomes in the cells after 18 hours of incubation. On the day of imaging, the study added 0.6 μL of 1 mM MitoTracker Deep Red FM stains (e.g., ThermoFisher #M22426) to the growth medium. The study incubated the cells for additional 30 minutes. When the study removed the growth medium, and the study washed the cells twice with clear Hank's balanced salt solutions (Corning HBSS #21-021-CV). The cells were fixed 4% paraformaldehyde (PFA, diluted from 16% PFA with PFA: PBS: ultrapure-water in 1:2:1 ratio, Electron Microscopy Sciences) at room temperature for 12 minutes. The study washed the cells twice with clear phosphate-buffered saline (e.g., Corning PBS #21-040-CM) and stored at 2.5 mL of PBS solution for imaging.

The study performed fixed nucleus and microtubule imaging with Hela cells once they reached ˜80% confluency. They were passaged and cultured in an 8-well glass-bottom μ-Slide (e.g., ibidi USA #80827). When cells reached ˜60% confluency in the slide, the study washed them with 500 μL culture medium once. Then, the study added 250 nM of Syto 16 green stains (e.g., ThermoFisher #S7578) in 200 μL culture medium to each well, incubating for 1 hour at 37° C. and in a 5% CO2 atmosphere. The cell fixation and immunostaining generally followed the N-STORM immunostaining protocol using the activator-reporter method. Briefly, the study then washed each well with 500 μL PBS (e.g., Corning #21-040-CV) once and fixed each well with 200 μL 3% PFA (Electron Microscopy Sciences): 0.1% glutaraldehyde (e.g., Sigma-Aldrich #G7651) in PBS at room temperature for 10 minutes. Extra aldehyde groups were reduced with 200 μL of 0.1% sodium borohydride (e.g., Sigma-Aldrich #452882), followed by 3 times washing with PBS for 5 minutes each. After that, cells were blocked with blocking buffer (e.g., 3% BSA (e.g., Sigma-Aldrich #A7906) with 0.2% Triton X-100 (e.g., Fisher BioReagents #BP151-100) in PBS) for 20 minutes. Then, 200 μL of primary antibody dilutions (e.g., BT7R, ThermoFisher, #MA5-16308, final concentration 10 μg/mL) in blocking buffer was added in each well and incubated for 30 minutes at room temperature, light avoided. Then, the study washed each well 5 times with 200 μL washing buffer (e.g., 0.2% BSA with 0.05% Triton X-100 in PBS) for 15 minutes per wash at room temperature. After washing, the study added 150 μL of secondary antibody dilutions (ThermoFisher, #A-21236, final concentration 3 μg/mL) in blocking buffer in each well and incubated for 30 minutes at room temperature, light avoided. Then, the study washed each well 3 times with 200 μL washing buffer for 10 minutes per wash at room temperature, followed by one time of washing in 500 μL PBS for 5 minutes. For better fluorescence imaging quality, cells were post-fixed 200 μL 3% PFA: 0.1% glutaraldehyde in PBS at room temperature for 10 minutes, followed by 3 times washing in 500 μL PBS for 5 minutes per wash. Finally, the study stored cells in 500 μL PBS for imaging purposes.

The study also performed live lysosomes with mitochondria and live actins with mitochondria imaging with Hela cells following the same cell culture protocol. For the lysosomes with mitochondria, on the day of imaging, the study first washed the imaging dish with a 2 mL culture medium once. Then, the study added 50 nM MitoTracker Deep Red FM stains (e.g., ThermoFisher #M22426) and 50 nM LysoTracker Green DND-26 (e.g., ThermoFisher #L7526) in 2 mL culture medium to the imaging dish. The cells were incubated for 30 minutes at 37° C. and in a 5% CO2 atmosphere. Then, the culture medium was discarded, and the cells were washed twice with 2 mL FluoroBrite DMEM (e.g., ThermoFisher #A1896701). Finally, the study added 2 mL of FluoroBrite DMEM to the imaging dish for imaging purposes. In general, cells were good for imaging at room temperature for 1-2 hours.

On the day of imaging live actins and mitochondria, the study first washed the imaging dish with a 2 mL culture medium once. Then, the study added 50 nM MitoTracker Deep Red FM stains (e.g., ThermoFisher #M22426) and 2 μL 1000X stock solution of CellMask Green Actin Tracking Stain (e.g., ThermoFisher #A57243) in 2 mL culture medium to the imaging dish. The cells were incubated for 30 minutes at 37° C. and in a 5% CO2 atmosphere. Then, the culture medium was discarded, and the cells were washed twice with 2 mL FluoroBrite DMEM (#A1896701 ThermoFisher). Finally, the study added 2 mL of FluoroBrite DMEM to the imaging dish for imaging purposes. In general, cells were good for imaging at room temperature for 1-2 hours.

System Design. The multicolor MSM system employed in the study incorporated 488-nm and 647-nm laser sources (e.g., Coherent OBIS laser source), a motorized translational sample stage (e.g., Applied Scientific Instrumentation MS-2000 Flat Top XY stage), a first optics assembly including a relay lens (RL), a dichroic mirror (DM), and an objective lens (OL) (e.g., Nikon CFI Plan Apochromat Lambda 100× Oil), and a microlens array (MLA) (e.g., RPC Photonics MLA, S100-f4-A). The system also incorporated a sensor (e.g., Hamamatsu ORCA-Flash 4.0 sCMOS camera with pixel size=65 nm) that was coupled with the first optics assembly.

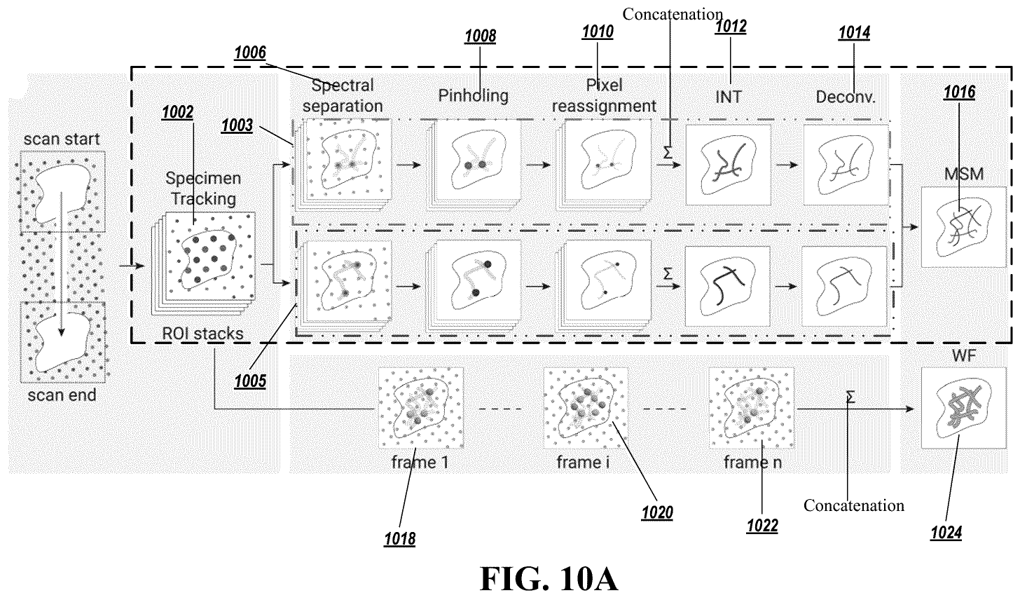

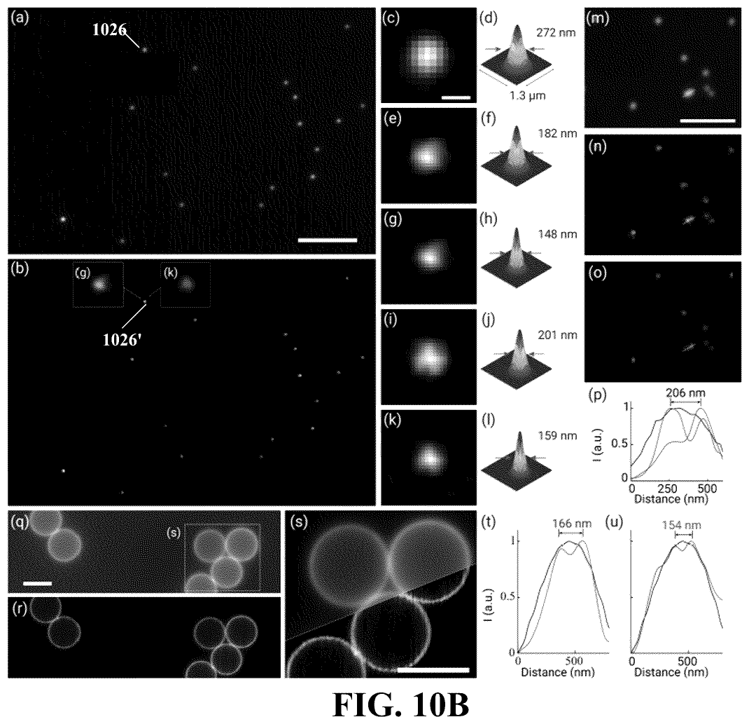

Experimental multicolor MSM and WF image reconstruction. The study conducted an experiment on WF and multicolor MSM image reconstruction and compared the quality of the reconstructed images produced from the two processes. FIG. 10A shows example image reconstruction processes for the multicolor MSM system and the WF system. The multicolor MSM image reconstruction process is highlighted by a dashed box.

At step 1002, the multifocal images (acquired from image acquisition process) were stabilized through a linear tracking plot. Specifically, a region of interest (ROI) was selected, and the motion of the multifocal image was tracked based on the displacement of the stage per acquisition frame (i.e., frame-to-frame basis), which subsequently generated a stack of frames (referred to as ROI stack). Each frame in the stack underwent flat-field correction (i.e., fit into a linear tracking plot) according to a pre-calibrated illumination intensity envelope.

At step 1006, each frame underwent spectral separation, wherein the coordinates of the excitation foci (acquired by a calibration of multifocal excitation patterns) on the frame were recorded into separate spectral channels 1003 and 1005.

At step 1008, in each spectral channel 1003 and 1005, the tracked frames underwent digital pinholes of 1×1, 2×2, 3×3, 4×4, or 5×5 pixels, according to the pre-calibrated array of the excitation foci, to reject out-of-focus light.

At step 1010, in each spectral channel 1003 and 1005, pixel reassignment was employed to downscale every focus on each pinholed frames, making them locally contracted by a factor of two and reassigned to a scaled image of the halved pixel size of 32.5 nm.

At step 1012, in each spectral channel 1003 and 1005, the pixel-reassigned frames were concatenated (i.e., summed up) to generate an intermediate image (referred to as INT).

At step 1014, the resolution-enhanced (e.g., √2×) intermediate frames may be produced by overlaying these pixel-reassigned images, which, by a further step of blind deconvolution, may be processed to realize the full 2× resolution improvement over the diffraction limit of the corresponding wide-field frame. The resolution-enhanced intermediate frames from spectral channels 1003 and 1005 were then merged to form the final multicolor super-resolution image 1016.

The multicolor image 1016 had color and better resolution than a WF image 1024 because the WF image 1024 was simply a concatenation of the frames in the ROI stack of frames, wherein each frame 1018, 1020, 1022, etc. does not have resolution enhancement as those at step 1014.

System characterization. To characterize multicolor MSM, the study imaged 100-nm multi-spectral fluorescent beads (e.g., ThermoFisher T7279) and recorded the scanned elemental images under the multifocal excitation using 488-nm and 647-nm lasers.

FIG. 10B shows an example WF and multicolor imaging of phantom samples for system characterization. Specifically, subpanels (a) and (b) show WF and multicolor MSM images of 100-nm Tetraspek fluorescent beads with emission peaks at 515 nm (i.e., green bead) and 680 nm (i.e., red bead), respectively.

Subpanel (c) shows a zoomed-in WF image of a microsphere 1026 (also referred to as 1026′) in subpanel (a). Subpanels (c) and (i) show zoomed-in intermediate images of the microsphere 1026′ in subpanel (b), wherein subpanel (e) represents the microsphere 1026′ as a green bead and subpanel (i) represents the microsphere 1026′ as red bead. Subpanels (g) and (k) show zoomed-in MSM images of the microsphere 1026′ in subpanel (b), wherein subpanel (g) represents the microsphere 1026′ as a green bead and subpanel (k) represents the microsphere 1026′ as red bead. Subpanels (d), (f), (h), (j), and (l) show corresponding FWHM graphs by Gaussing fitting of Subpanels (c), (e), (g), (i), and (k) respectively demonstrating enhanced resolution in both spectral channels (i.e., green and red beads).

Widefield (subpanel m) and super-resolution (subpanels n,o) images exhibited two nearby beads separated at 206 nm below the diffraction-limit were resolvable by MSM (subpanel p). Subpanels (q) and (r) show wide-field and multicolor MSM images of 6-μm surface-stained fluorescent microspheres. Subpanel(s) shows a zoomed-in montage of wide-field and super-resolution images of the boxed “s” region in subpanel (q), exhibiting enhanced resolution and contrast by multicolor MSM. Subpanels (t) and (u) show cross-sectional intensity profiles along the yellow lines as marked in subpanels (q) and (r), respectively, showing resolved structures in both 515-nm (subpanel t) and 680-nm (subpanel u) channels (i.e., green and red beads).

In FIG. 10B, when using MSM, the multicolor super-resolution image (subpanel b) exhibited a higher contrast and improved resolution in both spectral channels, in comparison with the corresponding wide-field image (subpanel a). In particular, the measurement displayed the full width at half maximum (FWHM) values of the bead images taken by MSM at ˜ 140-160 nm in the blue and red channels (as shown in subpanels (h) and (l)), respectively, consistent with the predicted resolution doubling (˜130 nm) convolved with the 100-nm profile of the phantom structure. The results exhibited a nearly two-fold improvement, as opposed to ˜272 nm for red color (286 nm, theoretically) as measured using the wide-field images in subpanel (c). In addition, nearby beads separated below the diffraction limit may be resolved in the multicolor MSM images as shown in subpanels (m)-(p). Additionally, as shown in subpanels (q)-(u), the MSM images of surface stained 6-μm fluorescent microspheres (e.g., ThermoFisher F24633) showed the good alignment of the multicolor objects, as well as their enhanced optical sectioning and resolution of adjacent structures as close as 150-160 nm in both spectral channels.

Imaging microtubules in HeLa cells. The study demonstrated multicolor imaging of biological samples with multicolor MSM.

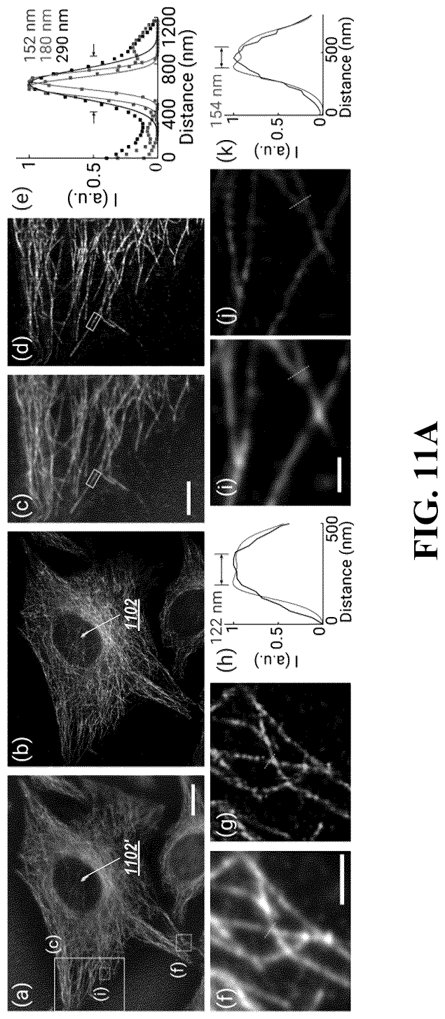

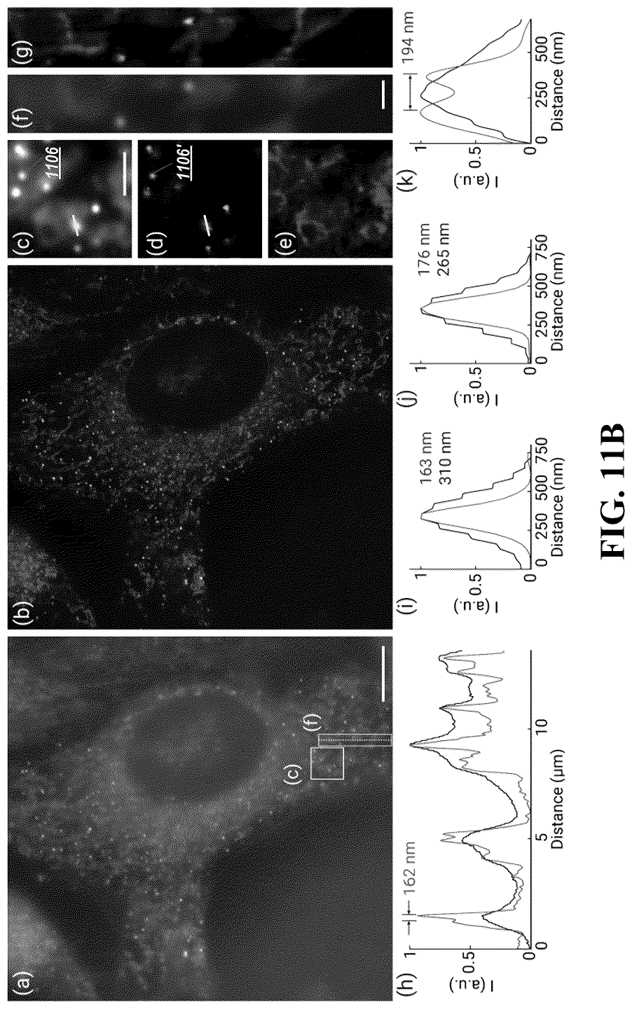

FIG. 11A shows example WF and multicolor MSM images of microtubules HeLa cells. Specifically, subpanels (a) and (b) show wide-field and multicolor MSM images of immune-stained microtubules for both 488-nm and 647-nm excitations, respectively. Subpanels (c) and (d) show zoomed-in WF and multicolor MSM images of the big yellow-boxed region “c” in subpanel (a). Subpanel (e) shows cross-sectional intensity profiles of a microtubule filament in the WF (e.g., black) and multicolor (e.g., blue and red) images.

Subpanels (f) and (g) show zoomed-in WF and multicolor MSM images of the white-boxed region “f” in subpanel (a), respectively. Subpanels (i) and (j) show zoomed-in WF and multicolor MSM images of the yellow boxed region “i” in subpanel (a), respectively. Subpanel (h) shows the cross-sectional intensity profiles along the dashed yellow line in subpanels (f) and (g), respectively, wherein the black profile represents the yellow line in subpanel (f) and the blue profile represents the yellow line in subpanel (g). Subpanel (k) shows the cross-sectional intensity profiles along the dashed yellow line in subpanels (i) and (j), respectively, wherein the black profile represents the yellow line in subpanel (i) and the red profile represents the yellow line in subpanel (j).

The study imaged microtubules in HeLa cells co-stained with both Alexa 488 and 647 (e.g., ThermoFisher A32723 and A21235, respectively). In FIG. 11A, the multicolor MSM image (subpanel b) of the thick nucleus region 1102 (also referred to as 1102′) of microtubules had better contrast and resolution than the WF image (subpanel a) of the thick nucleus region 1102′ of the microtubules. As shown in subpanels (c) and (d), the MSM images showed the co-localization of the delicate tubular structures revealed by both spectral labels. The co-labeled individual filaments exhibited consistent sub-diffraction-limited FWHM values at 150-180 nm in both channels as shown in subpanel (c), suggesting the agreement with the theoretical prediction of the immuno-stained microtubules (50-60 nm) [22′] convolved with the resolution (<150 nm) of the system. Furthermore, microtubule filaments that were separated as close as 122 nm and 154 nm may be resolvable using MSM as shown in subpanels (f)-(k), implying the two-fold resolution enhancement over the diffraction limit, consistent with the measurements using phantom samples as in FIG. 10.

Imaging peroxisomes and mitochondria. The study also performed super-resolution MSM imaging of peroxisomes and mitochondria in HeLa cells.

FIG. 11B shows example wide-field (WF) and multicolor MSM images of peroxisomes and mitochondria in Hela cells. Specifically, subpanels (a) and (b) show WF and multicolor MSM images of peroxisomes (green) and mitochondria (red) labeled with GFP and MitoTracker, respectively. Subpanel (c) shows a zoomed-in WF image of the white boxed region “c” in subpanel (a). Subpanels (d) and (e) show zoomed-in multicolor MSM images of the boxed region “c” in subpanel (a). Specifically, subpanel (d) used a green channel (i.e., green bead), and subpanel (e) used a red channel (i.e., red bead). Subpanels (f) and (g) show zoomed-in WF and multicolor MSM images of the yellow boxed region “f” in subpanel (a), respectively, demonstrating enhanced optical sectioning and resolution.

Subpanel (h) shows cross-sectional intensity profiles of mitochondria along the white dashed line in subpanel (a), wherein the black profile represents WF details and the red profile represents multicolor (e.g., red) MSM details. Subpanels (i) and (j) show cross-sectional intensity profiles of the peroxisome 1106 (also referred to as 1106′) in WF and multicolor MSM images. Subpanel (k) shows cross-sectional intensity profiles across the cluster of peroxisomes 1106, wherein the black profile represents cross-sectional intensity along the yellow line in subpanel (c), and the blue profile represents cross-sectional intensity along the yellow line in subpanel (d).

The interactions of the two organelles were identified in various cell types to function closely in the regulation of cellular metabolism and signaling pathways [23′]. In FIG. 11B, multicolor MSM simultaneously acquired peroxisomes and mitochondria that were labeled with GFP (e.g., ThermoFisher C10604) and MitoTracker (e.g., ThermoFisher M22426), respectively. The two organelles were densely packed in the cellular space, becoming less distinguishable due to the low image contrast and resolution in the wide-field image (subpanel a). On the contrary, as shown in subpanel (a)-subpanel (g), the multifocal excitation and computational processing (pinholing and deconvolution) in multicolor MSM permitted effective image sectioning and enhanced resolution of the intracellular organelle details that were poorly detectable by wide-field microscopy. For example, complex mitochondrial structural networks may be displayed spanning the cells, and their finer features at 100-200 nm may be substantially recovered using MSM as shown in subpanel (h). Meanwhile, the individual peroxisomes (typically 0.1-1 μm [24′]) exhibited FWHM values at ˜170 nm, in comparison with the wide-field measurement at ˜300 nm as shown in subpanel (i) and subpanel (j), and the clusters of closely located peroxisomes below the diffraction limit may be resolved using MSM as shown in subpanel (k). These results demonstrated the ability of MSM to simultaneously visualize multiple subcellular structural details with improved image quality and contents.

### Discussion

Fluorescence microscopy provides biological research with high-resolution, sensitive, and specific exploration of biological systems [1], [2]. The development of super-resolution microscopy techniques in the past decade resolved the inherent physical diffraction-limited barriers of traditional optical microscopy, unveiling subcellular features with unprecedented clarity [3], [4], [5], [6], [7]. Amongst these techniques, structured illumination microscopy (SIM) harnesses patterned illumination to recover high spatial frequencies,

extracting sub-diffraction-limited details from emitted fluorescence [8], [9], [10], [11]. SIM and its associated methodologies have attracted increasing interest due to their effective resolution doubling, rapid image acquisition, and compatibility with standard sample preparation protocols [12].

In particular, recent advances in image-scanning microscopy (ISM), a confocal form of SIM, enhances the super-resolution capabilities of traditional interference-based SIM [13], [14], [15], [16], [17], [18]. ISM employs diffraction-limited focal excitation, capturing all permissible spatial frequencies of the microscope and a detector array, with each pixel functioning as a discrete pinhole [19], [20]. This strategy, as a result, combines the strengths of both structured illumination and confocal microscopy, offering enhanced optical sectioning, an uncompromised signal-to-noise ratio (SNR), rapid volumetric acquisition, and optical super-

resolution through subsequent spatial-frequency demixing [21], [22], [23]. However, the wider adoption of ISM techniques remains constrained by existing optical configurations that entail intricate instruments and precise alignment and calibration. Furthermore, the scanning processes in ISM systems, which involve confocal spinning disks, galvanometric mirrors, or digital micromirror devices, hinder convenient and cost-effective integration with commonly used frameworks, such as epi-fluorescence microscopes.

To address these problems, an exemplary multifocal scanning microscopy (MSM), an ISM system allowing super-resolution imaging with simultaneous multicolor and/or 3D acquisition and minimal instrumental complexity, was developed. In particular, unlike existing spot-scanning schemes, MSM implements a stationary multi-foci configuration by using the motion of the specimens, realizing super-resolution microscopy through a general epi-fluorescence platform.

The study demonstrated the MSM system with various phantom and biological specimens, and the results presented effective resolution doubling, optical sectioning, and contrast enhancement. MSM, as a highly accessible and compatible super-resolution technique, may offer a promising methodological pathway for broad cell biological discoveries.

### Conclusion

It must also be noted that, as used in the specification and the appended claims, the singular forms “a,” “an,” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.

### REFERENCE LIST #1

[1] C. A. Combs, and H. Shroff, “Fluorescence Microscopy: A Concise Guide to Current Imaging Methods,” Curr Protoc Neurosci 79, 2 1 1-2 1 25 (2017).
[2] J. W. Lichtman, and J. A. Conchello, “Fluorescence microscopy,” Nat Methods 2, 910-919 (2005).
[3] B. Huang, H. Babcock, and X. Zhuang, “Breaking the diffraction barrier: super-resolution imaging of cells,” Cell 143, 1047-1058 (2010).
[4] L. Schermelleh, A. Ferrand, T. Huser, C. Eggeling, M. Sauer, O. Biehlmaier, and G. P. C. Drummen, “Super-resolution microscopy demystified,” Nat Cell Biol 21, 72-84 (2019).
[5] C. Bond, A. N. Santiago-Ruiz, Q. Tang, and M. Lakadamyali, “Technological advances in super-resolution microscopy to study cellular processes,” Mol Cell 82, 315-332 (2022).
[6] Z. Liu, L. D. Lavis, and E. Betzig, “Imaging live-cell dynamics and structure at the single-molecule level,” Mol Cell 58, 644-659 (2015).
[7] S. J. Sahl, S. W. Hell, and S. Jakobs, “Fluorescence nanoscopy in cell biology,” Nat Rev Mol Cell Biol 18, 685-701 (2017).
[8] M. G. Gustafsson, “Surpassing the lateral resolution limit by a factor of two using structured illumination microscopy,” J Microsc 198, 82-87 (2000).
[9] J. Demmerle, C. Innocent, A. J. North, G. Ball, M. Muller, E. Miron, A. Matsuda, I. M. Dobbie, Y. Markaki, and L. Schermelleh, “Strategic and practical guidelines for successful structured illumination microscopy,” Nat Protoc 12, 988-1010 (2017).
[10] R. Heintzmann, and T. Huser, “Super-Resolution Structured Illumination Microscopy,” Chemical Reviews 117, 13890-13908 (2017).
[11] F. Ströhl, and C. F. Kaminski, “Frontiers in structured illumination microscopy,” Optica 3, 667-677 (2016).
[12] Y. Wu, and H. Shroff, “Faster, sharper, and deeper: structured illumination microscopy for biological imaging,” Nat Methods 15, 1011-1019 (2018).
[13] C. B. Muller, and J. Enderlein, “Image scanning microscopy,” Phys Rev Lett 104, 198101 (2010).
[14] E. N. Ward, and R. Pal, “Image scanning microscopy: an overview,” J Microsc 266, 221-228 (2017).
[15] I. Gregor, and J. Enderlein, “Image scanning microscopy,” Curr Opin Chem Biol 51, 74-83 (2019).
[16] A. G. York, P. Chandris, D. D. Nogare, J. Head, P. Wawrzusin, R. S. Fischer, A. Chitnis, and H. Shroff, “Instant super-resolution imaging in live cells and embryos via analog image processing.” Nat Methods 10, 1122-1126 (2013).
[17] A. G. York, S. H. Parekh, D. Dalle Nogare, R. S. Fischer, K. Temprine, M. Mione, A. B. Chitnis, C. A. Combs, and H. Shroff, “Resolution doubling in live, multicellular organisms via multifocal structured illumination microscopy,” Nat Methods 9, 749-754 (2012).
[18] S. Roth, C. J. Sheppard, K. Wicker, and R. Heintzmann, “Optical photon reassignment microscopy (OPRA),” Optical Nanoscopy 2, 1-6 (2013).
[19] C. J. Sheppard, S. B. Mehta, and R. Heintzmann, “Superresolution by image scanning microscopy using pixel reassignment,” Opt Lett 38, 2889-2892 (2013).
[20] C. J. R. Sheppard, M. Castello, G. Tortarolo, T. Deguchi, S. V. Koho, G. Vicidomini, and A. Diaspro, “Pixel reassignment in image scanning microscopy: a re-evaluation,” J Opt Soc Am A Opt Image Sci Vis 37, 154-162 (2020).
[21] C. Roider, R. Piestun, and A. Jesacher, “3D image scanning microscopy with engineered excitation and detection,” Optica 4, 1373-1381 (2017).
[22] S. Li, J. Wu, H. Li, D. Lin, B. Yu, and J. Qu, “Rapid 3D image scanning microscopy with multi-spot excitation and double-helix point spread function detection,” Opt Express 26, 23585-23593 (2018).
[23] G. Tortarolo, A. Zunino, F. Fersini, M. Castello, S. Piazza, C. J. R. Sheppard, P. Bianchini, A. Diaspro, S. Koho, and G. Vicidomini, “Focus image scanning microscopy for sharp and gentle super-resolved microscopy,” Nat Commun 13, 7723 (2022).
[24] K. Weber, P. C. Rathke, and M. Osborn, “Cytoplasmic microtubular images in glutaraldehyde-fixed tissue culture cells by electron microscopy and by immunofluorescence microscopy,” Proc Natl Acad Sci U S A 75, 1820-1824 (1978).
[25] J. T. C. Liu, A. K. Glaser, K. Bera, L. D. True, N. P. Reder, K. W. Eliceiri, and A. Madabhushi, “Harnessing non-destructive 3D pathology,” Nat Biomed Eng 5, 203-218 (2021).
[26] J. Almagro, H. A. Messal, M. Zaw Thin, J. van Rheenen, and A. Behrens, “Tissue clearing to examine tumour complexity in three dimensions,” Nat Rev Cancer 21, 718-730 (2021).
[27] A. Zunino, E. Slenders, F. Fersini, A. Bucci, M. Donato, and G. Vicidomini, “Open-source tools enable accessible and advanced image scanning microscopy data analysis,” Nature Photonics, 1-2 (2023).
[28] J. Mertz, “Strategies for volumetric imaging with a fluorescence microscope,” Optica 6, 1261-1268 (2019).
[29] M. J. Fanous, and G. Popescu, “GANscan: continuous scanning microscopy using deep learning deblurring,” Light: Science & Applications 11, 265 (2022).
[30] W. Zhao, S. Zhao, L. Li, X. Huang, S. Xing, Y. Zhang, G. Qiu, Z. Han, Y. Shang, D. E. Sun, C. Shan, R. Wu, L. Gu, S. Zhang, R. Chen, J. Xiao, Y. Mo, J. Wang, W. Ji, X. Chen, B. Ding, Y. Liu, H. Mao, B. L. Song, J. Tan, J. Liu, H. Li, and L. Chen, “Sparse deconvolution improves the resolution of live-cell super-resolution fluorescence microscopy,” Nat Biotechnol 40, 606-617 (2022).
[31] B. Mandracchia, J. Son, and S. Jia, “Super-resolution optofluidic scanning microscopy,” Lab Chip 21, 489-493 (2021).
[32] A. G. York, P. Chandris, D. D. Nogare, J. Head, P. Wawrzusin, R. S. Fischer, A. Chitnis, and H. Shroff, “Instant super-resolution imaging in live cells and embryos via analog image processing,” Nat Methods 10, 1122-1126 (2013).
[33] A. G. York, S. H. Parekh, D. Dalle Nogare, R. S. Fischer, K. Temprine, M. Mione, A. B. Chitnis, C. A. Combs, and H. Shroff, “Resolution doubling in live, multicellular organisms via multifocal structured illumination microscopy,” Nat Methods 9, 749-754 (2012).
[34] Hammatsu Photonics K.K (2018). ORCA-Flash4.0 V3 Digital CMOS camera C13440-20CU Technical note. Hamamtsu Photonics K.K
[35] B. Mandracchia, J. SOn and S.Jia, Lab Chip 21(3), 489 (2021)
[36] A. G. York, P. Chandris, D. D. Nogare, et al., “Instant super-resolution imaging in live cells and embryos via analog image processing,” Nat. Methods 10(11), 1122-1126 (2013).
[37] D. Dan, M. Lei, B. Yao, et al., “DMD-based LED-illumination super-resolution and optical sectioning microscopy,” Sci. Rep. 3(1), 1116 (2013).
[38] S. Abrahamsson, H. Blom, A. Agostinho, et al., “Multifocus structured illumination microscopy for fast volumetric super-resolution imaging,” Biomed. Opt. Express 8(9), 4135-4140 (2017).
[39] E. J. Botcherby, R. Juskaitis, M. J. Booth, et al., “Aberration-free optical refocusing in high numerical aperture microscopy,” Opt. Lett. 32(14), 2007-2009 (2007).
[40] K. Yoon, K. Han, K. Tadesse, et al., “Simultaneous Multicolor Multifocal Scanning Microscopy,” ACS Photonics 10(9), 3035-3041 (2023).
[41] R. Tenne, U. Rossman, B. Rephael, et al., “Super-resolution enhancement by quantum image scanning microscopy,” Nat. Photonics 13(2), 116-122 (2019).
[42] A. Zunino, E. Slenders, F. Fersini, et al., “Open-source tools enable accessible and advanced image scanning microscopy data analysis,” Nat. Photon. 17(6), 457-458 (2023).
[43] A. Rossetta, E. Slenders, M. Donato, et al., “The BrightEyes—TTM as an open-source time-tagging module for democratising single-photon microscopy,” Nat. Commun. 13(1), 7406 (2022).
[44] M. J. Fanous and G. Popescu, “GANscan: continuous scanning microscopy using deep learning deblurring,” Light: Sci. Appl. 11(1), 265 (2022).
[45] A. Sroda, A. Makowski, R. Tenne, et al., “SOFISM: Super-resolution optical fluctuation image scanning microscopy,” Optica 7(10), 1308 (2020).
[46] A. C. Descloux, K. S. Gruβmayer, V. Navikas, et al., “Experimental combination of super-resolution optical fluctuation imaging with structured illumination microscopy for large fields-of-view,” Acs Photonics 8(8), 2440-2449 (2021).
[47] M. Buttafava, F. Villa, M. Castello, et al., “SPAD-based asynchronous-readout array detectors for image-scanning microscopy,” Optica 7(7), 755-765 (2020).
[48] J. Mertz, “Strategies for volumetric imaging with a fluorescence microscope,” Optica 6(10), 1261-1268 (2019).
[49] M. Castello, G. Tortarolo, M. Buttafava, et al., “A robust and versatile platform for image scanning microscopy enabling super-resolution FLIM,” Nat. Methods 16(2), 175-178 (2019).
[50] B. Mandracchia, J. Son, and S. Jia, “Super-resolution optofluidic scanning microscopy,” Lab Chip 21(3), 489-493 (2021).
[51] J. T. C. Liu, A. K. Glaser, K. Bera, et al., “Harnessing non-destructive 3D pathology,” Nat. Biomed. Eng. 5(3), 203-218 (2021).
[52] J. Almagro, H. A. Messal, M. Zaw Thin, et al., “Tissue clearing to examine tumour complexity in three dimensions,” Nat. Rev. Cancer 21(11), 718-730 (2021).

### REFERENCE LIST #2

[1′] Sahl, S.J., Hell, S.W. & Jakobs, S. Fluorescence nanoscopy in cell biology. Nat Rev Mol Cell Biol 18, 685-701 (2017).
[2′] Sigal, Y.M., Zhou, R. & Zhuang, X. Visualizing and discovering cellular structures with super-resolution microscopy. Science 361, 880-887 (2018).
[3′] Liu, Z., Lavis, L.D. & Betzig, E. Imaging live-cell dynamics and structure at the single-molecule level. Mol Cell 58, 644-659 (2015).
[4′] Gustafsson, M.G. et al. Three-dimensional resolution doubling in wide-field fluorescence microscopy by structured illumination. Biophys J 94, 4957-4970 (2008).
[5′] Schermelleh, L. et al. Subdiffraction multicolor imaging of the nuclear periphery with 3D structured illumination microscopy. Science 320, 1332-1336 (2008).
[6′] Li, X. et al. Three-dimensional structured illumination microscopy with enhanced axial resolution. Nat Biotechnol epub, 1-13 (2023).
[7′] Rodermund, L. et al. Time-resolved structured illumination microscopy reveals key principles of Xist RNA spreading. Science 372, eabe7500 (2021).
[8′] Wu, Y. & Shroff, H. Faster, sharper, and deeper: structured illumination microscopy for biological imaging. Nat Methods 15, 1011-1019 (2018).
[9′] Schermelleh, L. et al. Super-resolution microscopy demystified. Nat Cell Biol 21, 72-84 (2019).
[10′] Muller, C.B. & Enderlein, J. Image scanning microscopy. Phys Rev Lett 104, 198101 (2010).
[11′] Gregor, I. & Enderlein, J. Image scanning microscopy. Curr Opin Chem Biol 51, 74-83 (2019).
[12′] Sheppard, C.J.R. Super-resolution in confocal imaging. Optik 80, 53-54 (1988).
[13′] York, A.G. et al. Instant super-resolution imaging in live cells and embryos via analog image processing. Nat Methods 10, 1122-1126 (2013).
[14′] York, A.G. et al. Resolution doubling in live, multicellular organisms via multifocal structured illumination microscopy. Nat Methods 9, 749-754 (2012).
[15′] Azuma, T. & Kei, T. Super-resolution spinning-disk confocal microscopy using optical photon reassignment. Opt Express 23, 15003-15011 (2015).
[16′] Castello, M. et al. A robust and versatile platform for image scanning microscopy enabling super-resolution FLIM. Nat Methods 16, 175-178 (2019).
[17′] Sheppard, C.J.R. et al. Pixel reassignment in image scanning microscopy: a re-evaluation. J Opt Soc Am A Opt Image Sci Vis 37, 154-162 (2020).
[18′] Schulz, O. et al. Resolution doubling in fluorescence microscopy with confocal spinning-disk image scanning microscopy. Proc Natl Acad Sci U S A 110, 21000-21005 (2013).
[19′] Markwirth, A. et al. Video-rate multi-color structured illumination microscopy with simultaneous real-time reconstruction. Nat Commun 10, 4315 (2019).
[20′] Mandracchia, B., Son, J. & Jia, S. Super-resolution optofluidic scanning microscopy. Lab Chip 21, 489-493 (2021).
[21′] Sheppard, C.J., Mehta, S.B. & Heintzmann, R. Superresolution by image scanning microscopy using pixel reassignment. Optics letters 38, 2889-2892 (2013).
[22′] Weber, K., Rathke, P.C. & Osborn, M. Cytoplasmic microtubular images in glutaraldehyde-fixed tissue culture cells by electron microscopy and by immunofluorescence microscopy. Proc Natl Acad Sci U S A 75, 1820-1824 (1978).
[23′] Fransen, M., Lismont, C. & Walton, P. The Peroxisome-Mitochondria Connection: How and Why? Int J Mol Sci 18, 1126 (2017).
[24′] Smith, J.J. & Aitchison, J.D. Peroxisomes take shape. Nat Rev Mol Cell Biol 14, 803-817 (2013).
[25′] Andreou, C., Weissleder, R. & Kircher, M.F. Multiplexed imaging in oncology. Nat Biomed Eng 6, 527-540 (2022).
[26′] Mertz, J. Strategies for volumetric imaging with a fluorescence microscope. Optica 6, 1261-1268 (2019).
[27′] Helle, Ø.I. et al. Structured illumination microscopy using a photonic chip. Nature Photonics 14, 431-438 (2020).
[28′] Zhanghao, K. et al. Super-resolution imaging of fluorescent dipoles via polarized structured illumination microscopy. Nat Commun 10, 4694 (2019).
[29′] Zhao, W. et al. Sparse deconvolution improves the resolution of live-cell super-resolution fluorescence microscopy. Nat Biotechnol 40, 606-617 (2022).
[30′] Mahecic, D. et al. Event-driven acquisition for content-enriched microscopy. Nat Methods 19, 1262-1267 (2022).

What is claimed is:

1. A system comprising:
one or more laser sources, including a first laser device;
a microlens array optically connected to the first laser device, the microlens array having a plurality of microlens elements configured to generate a plurality of beams from a laser beam of the first laser source to provide a multifocal excitation pattern;
an optics assembly coupled to the microlens array, the optics assembly being configured to generate diffraction-limited foci from the multifocal excitation pattern and project the diffraction-limited foci on a sample; and
a sensor configured to capture fluorescence rays emitted from the sample as fluorescent signals to provide raw multi-focal images, including (i) a first image captured at a first position and (ii) a second image captured at a second position,
wherein at least one of the sample or the optics assembly is configured to move during a scan to provide a capture of the sample by the sensor while the sample or the multifocal excitation pattern is moving in relation to one another, and
wherein the first image and the second image are used to generate a high-resolution image via a reconstruction algorithm.

2. The system of claim 1 further comprising:
a motorized stage configured to move the sample in one or more directions to provide (i) the first image at the first position and (ii) the second image captured at the second position.

3. The system of claim 1, wherein the optics assembly is configured to move to allow the scanning of the sample at different orientations with respect to the camera to provide (i) the first image at the first position and (ii) the second image captured at the second position.

4. The system of claim 1, wherein the one or more laser sources include a second laser device, the system further comprising a second optics assembly to combine (i) the first laser beam and (ii) a second laser beam from the second laser device to generate the laser beam.

5. The system of claim 1, wherein the one or more laser sources include a second laser device, the system further comprising a second optics assembly having (i) a first portion configured to direct the laser beam of the first laser device to a first portion of the microlens array and (ii) a second portion configured to direct a second laser beam to a second portion of the microlens array.

6. The system of claim 1, wherein the first laser beam and the second laser beam have different wavelengths.

7. The system of claim 1, wherein the first laser beam and the second laser beam have same wavelengths.

8. The system of claim 1 comprising:
an image processing unit having a processor and a memory having instructions stored thereon to generate the high-resolution image, wherein execution of the instructions by the processor causes the processor to:
generate, via a digital pinhole mask, one or more pinholed images from the first image and second image, wherein the one or more pinholed images eliminate out-of-focus lights from the first image and second image;
generate one or more intermediate images by reassigning pixels of the pinholed images; and
produce super-resolution images by overlaying the one or more intermediate images with each other in a deconvolution operation.

9. The system of claim 8, wherein the image processing unit is further configured to track, via a tracking pattern, the raw multi-focal images to remove non-uniform movement errors.

10. The system of claim 1 further comprising:
a controller configured to perform calibration to identify a location of each illumination spot across a field of view of the sensor, wherein the each illumination spot corresponds to each of the diffraction-limited foci.

11. The system of claim 10, wherein for multicolor reconstruction, the system comprises an image processing unit having a processor and a memory having instructions stored thereon to generate the high-resolution image, wherein execution of the instructions by the processor causes the processor to:
receive stored coordinates of the diffraction-limited foci acquired using a calibration slide containing a uniform distribution of fluorescent dyes, wherein the stored coordinates are recorded into separate spectral channels;
generate, via a digital pinhole mask, two or more pinholed images from the first image and second image, wherein the two or more pinholed images eliminate out-of-focus lights from the first image and second image, and wherein the two or more pinholed images are separated into the separate spectral channels based on the stored coordinates;
generate one or more intermediate images by reassigning pixels of the pinholed images; and
produce the high-resolution image by overlaying the one or more intermediate images with each other.

12. The system of claim 1 further comprising:
a controller configured to (i) direct the sample in one or more directions, (ii) direct operations of the one or more laser sources, and (iii) direct scanning operations of the sensor.

13. The system of claim 1, wherein the microlens array is multicolor microlens array comprising (i) a first set of first color array elements and (ii) a second set of second color array elements.

14. The system of claim 13, wherein the first set of first color array elements forms a first grid, and the second set of second color array elements forms a second grid, wherein the first grid is interposed among the second grid.

15. The system of claim 1, wherein the optics assembly is configured to direct the fluorescent rays emitted from the sample to the sensor.

16. A method comprising:
generating a laser beam from a laser source;
scanning a sample by:
generating a plurality of beams from the laser beam to provide a multifocal excitation pattern using a microlens array;
directing the multifocal excitation pattern to project the multifocal excitation pattern as diffraction-limited foci on a sample while the sample is moving;
moving the sample in a first direction; and
capturing fluorescence rays emitted from the sample as fluorescent signals as the sample is moving to generate (i) a first image at a first position and (ii) a second image at a second position; and
reconstructing a high-resolution image, via a reconstruction operation, using the first image and the second image.

17. The method of claim 16, wherein scanning operations comprise one or more directions, including a first direction, a second direction, a third direction, and a combination thereof.

18. The method of claim 16 wherein, for 3D image reconstruction, the reconstruction operation involves:
generating, via a digital pinhole mask, one or more pinholed images from the first image and second image, wherein the one or more pinholed images eliminate out-of-focus lights from the first image and second image;
generating one or more intermediate images by reassigning pixels of the pinholed images; and
producing super-resolution images by overlaying the one or more intermediate images with each other in a deconvolution operation.

19. The method of claim 16, wherein, for multicolor reconstruction, the reconstruction operation involves:
receiving stored coordinates of the diffraction-limited foci acquired using a calibration slide containing a uniform distribution of fluorescent dyes, wherein the stored coordinates are recorded into separate spectral channels;
generating, via a digital pinhole mask, two or more pinhole images from the first image and second image, wherein the two or more pinholed images eliminate out-of-focus lights from the first image and second image, and wherein the two or more pinholed images are separated into the separate spectral channels based on the stored coordinates;
generating one or more intermediate images by reassigning pixels of the pinholed images; and
producing the high-resolution image by overlaying the one or more intermediate images with each other.

20. A non-transitory computer readable medium having instructions stored thereon, wherein execution of the instructions by a processor causes the processor to:
direct generation of a laser beam from a laser source;
direct scanning of a sample by:
generating a plurality of beams from the laser beam to provide a multifocal excitation pattern using a microlens array;
directing the multifocal excitation pattern to project the multifocal excitation pattern as diffraction-limited foci on a sample while the sample is moving;
moving the sample in a first direction;
capturing fluorescence rays emitted from the sample as fluorescent signals as the sample is moving to generate (i) a first image at a first position and (ii) a second image at a second position; and
reconstructing a high-resolution image, via a reconstruction operation, using the first image and the second image.
